(19) United States
(12) Patent Application Publication
(10) Pub. No.: US 2023/0350158 A1
(43) Pub. Date: Nov. 2, 2023

(54) Low Refractive Power Inner Lens Focusing Unit and Optical System Thereof

(71) Applicant: Huawei Technologies Co., Ltd., Shenzhen (CN)

(72) Inventors: Yasuhide Nihei, Yokohama (JP); Takumi Matsui, Yokohama (JP)

(21) Appl. No.: 18/350,290

(22) Filed: Jul. 11, 2023

Related U.S. Application Data
(63) Continuation of application No. PCT/CN2021/079130, filed on Mar. 4, 2021.

(51) Int. Cl. G02B 7/09; G02B 13/02; G02B 15/20

(52) U.S. Cl. CPC G02B 7/09; G02B 13/02; G02B 15/20

(57) ABSTRACT

An inner focusing lens unit includes at least one positive lens group and at least one negative lens group. The inner focusing lens unit is configured to be placed within a flange back between an imaging lens and an image sensor surface to provide a focusing function when the negative lens group is moved toward the imaging surface to focus at a nearer object distance when focusing from infinity to a minimum object distance (MOD).

### CROSS-REFERENCE TO RELATED APPLICATIONS

This application is a continuation of International Patent Application No. PCT/CN2021/079130 filed on Mar. 4, 2021, the disclosure of which is hereby incorporated by reference in its entirety.

### TECHNICAL FIELD

The present disclosure relates to an optical system, and more particularly to a focusing system for cameras.

### BACKGROUND

There are several types of focusing methods generally known and used to focus a lens. Among these methods, two main methods are generally known to focus telephoto lens. One of the two methods is the “whole group extension” method, which moves the entire lens group by focusing. In this method, the total length of the lens or total track length (TTL) changes. The other method is the “inner focusing” method, which moves one or more lens group(s) inside the lens system to focus without changing the TTL. The “whole group extension” method is generally used for mobile devices such as mobile phones and tablets for the advantages of a simple structure and good productivity, while the inner focusing system is often used for still cameras or video cameras for the advantages of a fixed TTL. On the other hand, the inner focusing system requires a more complex mechanical and optical structure since a part of the optics must be moved within the lens system and the like. So mass production becomes more difficult due to the need for higher precision manufacturing technology since the product accuracy increases the influence of the optical performances.

Therefore, there has been always a need for an inner focusing lens to be used for mobile devices such as mobile phones and tablets for the advantages of a fixed TTL. However, the introduction of the inner focus lens on mobile devices has been hesitated due to complexity of the assembly and the structure.

For the “whole group extension” method, focusing has less effect on the optical performances since the entire optics are moved, which makes mass production easier. However, these methods are not preferable for miniaturization since its TTL changes, especially not for a telephoto lens which generally has an even longer stroke of the entire optics and requires a longer focal length compared to a wide-angle lens. The focusing stroke is correlated with its focal length and a telephoto lens must extend the lens for a longer focusing stroke to focus from infinity (INF) to the minimum object distance (MOD). Therefore, applying the “whole group extension” method to small cameras for mobile devices is not preferable, especially not for a telephoto lens. In addition, the “whole group extension” method has another problem in that the amount of extension becomes very large when focusing on a subject at a nearby point. In addition, it is necessary to assemble and inspect the whole lens system including the focusing drive, which poses a problem in mass productivity.

For example, the refractive power of an inner focus type lenses disclosed in some approaches is too high to reduce the manufacturing error sensitivity in order to improve mass productivity, and as a result, the focusing stroke becomes too long.

In the case of a “whole group extension” optical system with an integrated structure disclosed in some approaches, the optical system has better mass productivity, but the TTL changes while focusing, which makes miniaturization difficult. This is a big problem since it makes the amount of extension of the TTL large especially when focusing on a subject at a nearby point.

Therefore, there is a need for an inner lens focusing system for a telephoto lens used for small cameras for mobile devices such as mobile phones and tablets, which includes a simple structure and high productivity. There is also a need for an inner lens focusing system having a short MOD, which was difficult to achieve with a compact size with the conventional “whole group extension” type focusing mechanism, when used in mobile devices.

### SUMMARY

The present disclosure mitigates and/or obviates the afore-mentioned disadvantages.

The primary objective of the focusing system of the present disclosure is to provide a low refractive power inner lens focusing unit and an optical system thereof to provide a fixed TTL, a short MOD, and high productivity.

The low refractive power inner lens focusing unit, also called the focusing lens unit, in accordance with the present disclosure has a very low refractive power of the entire optical unit, and comprises at least one positive lens group and at least one negative lens group, wherein the negative lens group is configured to move toward the imaging surface when focusing from INF to MOD, and vice versa. Occasionally, the at least one positive lens group of a focusing lens unit may also be configured to move toward the object side to compensate for disturbed aberrations which may occur when focusing. It is assumed that the low refractive power inner lens focusing unit according to the present disclosure can be used with an imaging lens which is the main lens unit for the optical system. The inner focus function is provided to the optical system by inserting a low refractive power inner lens focusing unit according to the present disclosure within the flange back between the main imaging lens and the image sensor surface to provide a focusing function with the imaging lens, while maintaining the optical performances of the main imaging lens.

According to one aspect of the present low refractive power inner lens focusing unit, when the magnification of the negative lens group of the focusing lens unit, which is configured to move during focusing, is β, it satisfies the relation:

0.5≤|1−β\hat{ }2|≤3.5, more preferably 0.7≤|1−β\hat{ }2|≤3.0 (i)

Satisfying these conditions (i) keeps the amount of the focusing stroke small enough to miniaturize the optical system and prevents the error sensitivity of moving the focusing lens unit from becoming too strong, which is disadvantageous in terms of manufacturing and mass production.

According to one aspect of the present low refractive power inner lens focusing unit, when the semi-diagonal length of the image sensor of the optical system used with the present focusing unit is IMH and the focal length of this focusing lens unit is Ff, it satisfies the relation:

|Ff|/IMH≥10, more preferably |Ff|/IMH≥17 (ii)

Satisfying these conditions (ii) prevents the refractive power of the focusing unit from becoming unnecessarily large with respect to the sensor size, which makes it unsuitable for miniaturization and causes deterioration of manufacturing error sensitivity and deterioration of mass productivity due to a substantial effect on the performances of the main imaging lens.

According to one aspect of the present low refractive power inner lens focusing unit, when the focal length of the combined main imaging lens is Fmain and the focal length of this focusing lens unit is Ff, it satisfies the relation:

Ff/Fmain≤0.55, more preferably Ff/Fmain≤0.4 (iii)

Satisfying these conditions (iii) avoids deterioration of manufacturing and mass productivity caused by making the refractive power of the focusing lens unit too strong and reducing the versatility of this optical system due to significant changes of the performance of the main imaging lens when the focusing lens unit is combined with the main imaging lens.

According to one aspect of the present low refractive power inner lens focusing unit, when the maximum optical effective diameter of the lens among the focusing lens unit is φmax and the distance between the facing lens surfaces between different lens groups of the focusing lens unit, which get close together at the INF lens position, is Dmin, it satisfies the relation:

Dmin/φmax<0.2, more preferably Dmin/φmax<0.1 (iv)

Satisfying these conditions (iv) keeps the effect by the focusing lens unit on the main imaging lens small enough to maintain the optical performances of the main imaging lens.

According to one aspect of the present low refractive power inner lens focusing unit, the facing lens surfaces between different lens groups of the focusing lens unit, which get close together at the INF lens position, have substantially corresponding surfaces. When the surface shape (SAG amount) of the surface on the object side of the facing lens surfaces, which is defined by the lens diameter height h, is Sob (h), and the surface shape (SAG amount) on the image plane side of the facing lens surfaces is Sim (h), they satisfy the relation:

0.5<abs (v)

According to one aspect of the present low refractive power inner lens focusing unit, the radius of the surface on the object side of the above-mentioned facing surfaces is Rob and the radius of the surface on the image side of the above mentioned facing surfaces is Rim, and it satisfies the relation:

0.5<Rob/Rim<2.0 (vi)

Satisfying conditions (v) and (vi) avoids where, since the surface shapes of the above mentioned facing surfaces are too different from each other to approximate them as a single lens unit with low aberration when the two surfaces approach, it becomes difficult to maintain the optical specifications of the main imaging lens.

According to a second aspect, a low refractive power inner lens focusing system is provided. The low refractive power inner lens focusing system comprises the low refractive power inner lens focusing unit of the present disclosure and a main imaging lens. The lens elements of the main imaging lens are fixed without a focusing unit since the low refractive power inner lens focusing unit provides the main imaging lens with the focusing function. Further, in the lens performance inspection process, various inspections can be performed only with the main imaging lens separately from the focusing lens unit, which facilitates manufacturing. On the other hand, by focusing with this focusing lens unit, it is possible to avoid changing the TTL and increasing the total length of the lens. It is possible to adopt the inner focusing method in which the total length does not change and the MOD is short. Further, since the focusing lens unit according to the present disclosure has very low refractive power, it can have a very small effect on the optical performances of the main imaging lens. Therefore, it can keep the manufacturing error sensitivity at a very low level, which enables realization of high manufacturability and mass productivity.

According to a third aspect, a camera is provided. The camera comprises a low refractive power inner lens focusing system and an image sensor. The low refractive power inner lens focusing system low refractive power inner lens focusing system is configured to input light, which is used to carry image data, to the image sensor; and the image sensor is configured to convert the image to digital image data.

According to a fourth aspect, a terminal is provided. The terminal such as mobile phones and tablets comprises at least one camera, which is provided in the third aspect, and a graphic processing unit (GPU). The GPU is connected to the camera. The camera is configured to obtain image data and input the image data into the GPU, and the GPU is configured to process the image data received from the camera.

The present disclosure will be presented in further detail from the following descriptions with accompanying drawings, which show, for purpose of illustration only, the preferred embodiments in accordance with the present disclosure.

### BRIEF DESCRIPTION OF DRAWINGS

The disclosure can be better understood from the following detailed description of non-limiting embodiments thereof, and by examining the accompanying drawings, in which:

FIG. 1A shows a cross-sectional illustration of an optical lens system in accordance with a first embodiment of the present disclosure at the INF lens position.

FIG. 1B shows a cross-sectional illustration of the optical lens system in accordance with the first embodiment of the present disclosure at the MOD lens position.

FIG. 1C shows a comparison of longitudinal spherical aberration of the main imaging lens and a combination of the main imaging lens and a focusing lens unit in accordance with the first embodiment of the present disclosure.

FIG. 1D shows a comparison of an astigmatic field of a main imaging lens and a combination of the main imaging lens and the focusing lens unit of the present disclosure in accordance with the first embodiment.

FIG. 1E shows a comparison of distortion of the main imaging lens and a combination of the main imaging lens and the focusing lens unit of the present disclosure in accordance with the first embodiment.

FIG. 2A shows a cross-sectional illustration of an optical lens system in accordance with the second embodiment of the present disclosure at the infinity lens position.

FIG. 2B shows a cross-sectional illustration of the optical lens system in accordance with a second embodiment of the present disclosure at the MOD lens position.

FIG. 2C shows a comparison of longitudinal spherical aberration of the main imaging lens and a combination of the main imaging lens and a focusing lens unit in accordance with the second embodiment of the present disclosure.

FIG. 2D shows a comparison of an astigmatic field of the main imaging lens and a combination of the main imaging lens and the focusing lens unit of the present disclosure in accordance with the second embodiment.

FIG. 2E shows a comparison of distortion of the main imaging lens and a combination of the main imaging lens and the focusing lens unit of the present disclosure in accordance with a second embodiment.

FIG. 3A shows a cross-sectional illustration of an optical lens system in accordance with a third embodiment of the present disclosure at the infinity lens position.

FIG. 3B shows a cross-sectional illustration of an optical lens system in accordance with the third embodiment of the present disclosure at the MOD lens position.

FIG. 3C shows a comparison of longitudinal spherical aberration of the main imaging lens and a combination of the main imaging lens and the focusing lens unit in accordance with the third embodiment of the present disclosure.

FIG. 3D shows a comparison of an astigmatic field of a main imaging lens and a combination of the main imaging lens and a focusing lens unit of the present disclosure in accordance with the third embodiment.

FIG. 3E shows a comparison of distortion of the main imaging lens and a combination of the main imaging lens and the focusing lens unit of the present disclosure in accordance with the third embodiment.

FIG. 4A shows a cross-sectional illustration of an optical lens system in accordance with a fourth embodiment of the present disclosure at the infinity lens position.

FIG. 4B shows a cross-sectional illustration of the optical lens system in accordance with a fourth embodiment of the present disclosure at the MOD lens position.

FIG. 4C shows a comparison of longitudinal spherical aberration of the main imaging lens and a combination of the main imaging lens and a focusing lens unit in accordance with the fourth embodiment of the present disclosure.

FIG. 4D shows a comparison of an astigmatic field of the main imaging lens and a combination of the main imaging lens and a focusing lens unit of the present disclosure in accordance with the fourth embodiment.

FIG. 4E shows a comparison of distortion of the main imaging lens and a combination of the main imaging lens and the focusing lens unit of the present disclosure in accordance with the fourth embodiment.

FIG. 5A shows a cross-sectional illustration of an optical lens system in accordance with a fifth embodiment of the present disclosure at the infinity lens position.

FIG. 5B shows a cross-sectional illustration of the optical lens system in accordance with the fifth embodiment of the present disclosure at the MOD lens position.

FIG. 5C shows a comparison of longitudinal spherical aberration of the main imaging lens and a combination of the main imaging lens and a focusing lens unit in accordance with the fifth embodiment of the present disclosure.

FIG. 5D shows a comparison of an astigmatic field of the main imaging lens and a combination of the main imaging lens and the focusing lens unit of the present disclosure in accordance with the fifth embodiment.

FIG. 5E shows a comparison of distortion of the main imaging lens and a combination of the main imaging lens and the focusing lens unit of the present disclosure in accordance with the fifth embodiment.

FIG. 6A shows a cross-sectional illustration of an optical lens system in accordance with a sixth embodiment of the present disclosure at the infinity lens position.

FIG. 6B shows a cross-sectional illustration of the optical lens system in accordance with the sixth embodiment of the present disclosure at the MOD lens position.

FIG. 6C shows a comparison of longitudinal spherical aberration of the main imaging lens and a combination of the main imaging lens and a focusing lens unit in accordance with the sixth embodiment of the present disclosure.

FIG. 6D shows a comparison of an astigmatic field of the main imaging lens and a combination of the main imaging lens and the focusing lens unit of the present disclosure in accordance with the sixth embodiment.

FIG. 6E shows a comparison of distortion of the main imaging lens and a combination of the main imaging lens and the focusing lens unit of the present disclosure in accordance with the sixth embodiment.

FIG. 7A shows a cross-sectional illustration of an optical lens system in accordance with a seventh embodiment of the present disclosure at infinity lens position.

FIG. 7B shows a cross-sectional illustration of the optical lens system in accordance with the seventh embodiment of the present disclosure at the MOD lens position.

FIG. 7C shows a comparison of longitudinal spherical aberration of the main imaging lens and a combination of the main imaging lens and the focusing lens unit in accordance with the seventh embodiment of the present disclosure.

FIG. 7D shows a comparison of an astigmatic field of the main imaging lens and a combination of the main imaging lens and the focusing lens unit of the present disclosure in accordance with the seventh embodiment.

FIG. 7E shows a comparison of distortion of the main imaging lens and a combination of the main imaging lens and the focusing lens unit of the present disclosure in accordance with the seventh embodiment.

FIG. 8A shows a cross-sectional illustration of an optical lens system in accordance with an eighth embodiment of the present disclosure at the infinity lens position.

FIG. 8B shows a cross-sectional illustration of the optical lens system in accordance with the eighth embodiment of the present disclosure at the MOD lens position.

FIG. 8C shows a comparison of longitudinal spherical aberration of the main imaging lens and a combination of the main imaging lens and the focusing lens unit in accordance with the eighth embodiment of the present disclosure.

FIG. 8D shows a comparison of an astigmatic field of the main imaging lens and a combination of the main imaging lens and the focusing lens unit of the present disclosure in accordance with the eighth embodiment.

FIG. 8E shows a comparison of distortion of the main imaging lens and a combination of the main imaging lens and the focusing lens unit of the present disclosure in accordance with the eighth embodiment.

FIG. 9A shows a cross-sectional illustration of an optical lens system in accordance with a ninth embodiment of the present disclosure at the infinity lens position.

FIG. 9B shows a cross-sectional illustration of the optical lens system in accordance with the ninth embodiment of the present disclosure at the MOD lens position.

FIG. 9C shows a comparison of longitudinal spherical aberration of the main imaging lens and a combination of the main imaging lens and the focusing lens unit in accordance with the ninth embodiment of the present disclosure.

FIG. 9D shows a comparison of an astigmatic field of the main imaging lens and a combination of the main imaging lens and the focusing lens unit of the present disclosure in accordance with the ninth embodiment.

FIG. 9E shows a comparison of distortion of the main imaging lens and a combination of the main imaging lens and the focusing lens unit of the present disclosure in accordance with the ninth embodiment.

FIG. 10 shows an implementation of the present disclosure.

### DETAILED DESCRIPTION OF THE EMBODIMENTS

The following embodiments of the low refractive power inner lens focusing system of the present disclosure will be described referring to the figures and the optical data. This lens system can be applied to small cameras for mobile devices such as mobile phones and tablets. In addition, the present optical system comprises a main imaging lens and a focusing lens unit. The following embodiments will be described as combinations of a main imaging lens having a good optical performance by itself and a focusing lens unit of the present disclosure. However, the focusing unit can be used with various general main imaging lenses since the focusing unit has very low refractive power and does not affect the optical performances of the main imaging lens when the focusing unit is inserted within the flange back between the main imaging lens and the image sensor surface to provide a focusing function with the main imaging lens.

Therefore, the main lens unit and the focusing lens unit can be inspected separately and increase productivity. A low refractive power inner lens focusing system makes it easier for the optical designer to choose or design a main imaging lens.

A low refractive power inner lens focusing system also achieves a short MOD and a fixed TTL, which are suitable features for a telephoto lens used especially for small cameras for mobile devices such as mobile phones and tablets.

### First Embodiment

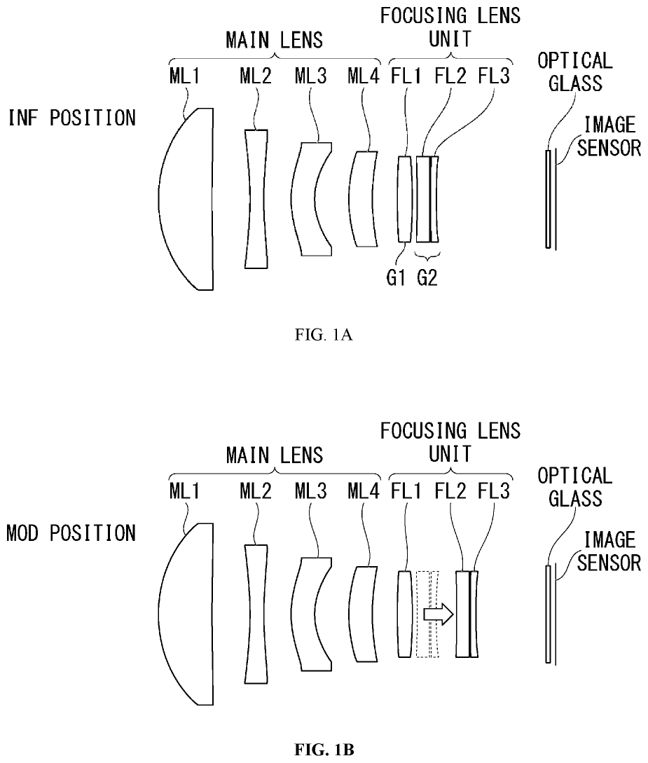

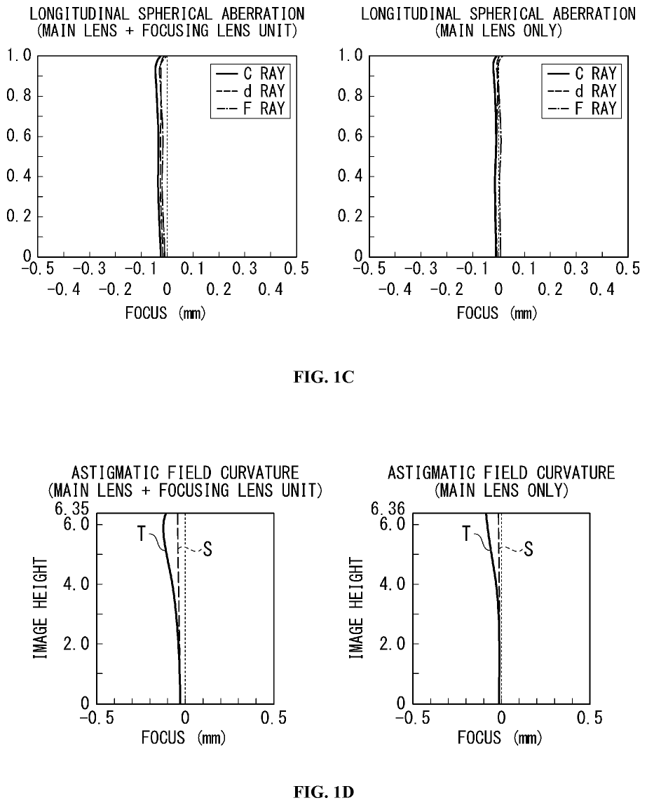

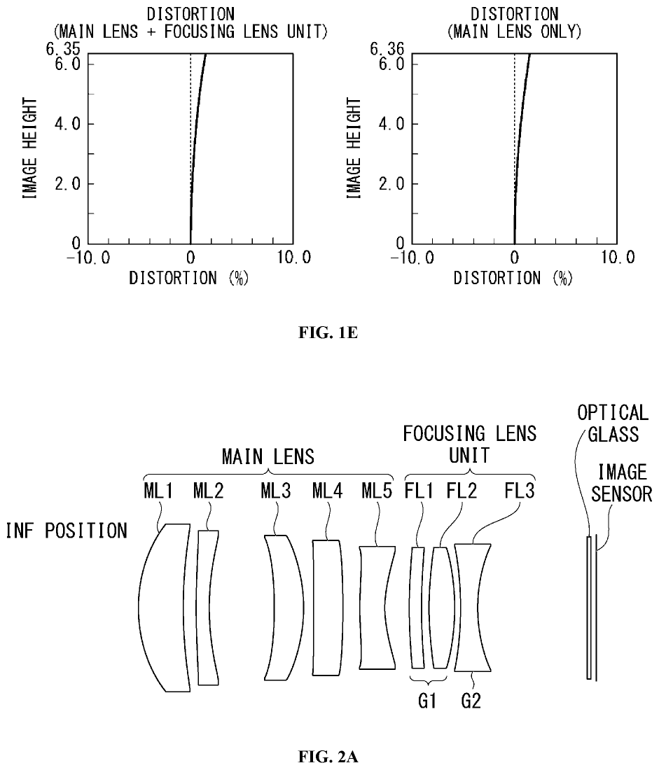

FIG. 1A shows a cross-sectional illustration of an optical lens system in accordance with a first embodiment of the present disclosure at the infinity lens position. A main imaging lens comprises lens elements ML1, ML2, ML3, and ML4, and a focusing unit comprises lens elements FL1, FL2, and FL3. In the focusing lens unit of this embodiment, a first positive lens group consists of FL1, and a second negative lens group consists of FL2 and FL3.

FIG. 1B shows a cross-sectional illustration of an optical lens system in accordance with the first embodiment of the present disclosure at the MOD lens position. The facing lens surfaces between FL1 and FL2 have a substantially corresponding surfaces.

FIGS. 1A and 1B show that only lens elements FL2 and FL3 of the focusing lens unit are moved together towards the image side to focus at a nearer object distance, and towards the object side to focus at a farther object distance. Therefore, the focus mechanism can be easily designed.

Table 1 shows the radius of curvature (r) and the thickness or separation (d) for each of the optical surfaces, and the refractive index (N), the Abbe number (v), and the effective diameter (φ) for each of the lens elements of the low refractive power inner lens focusing system of the first embodiment. The term “Stop” stands for an iris surface.

TABLE 1

| | | | | Refractive | Abbe | Effective |
|---|---|---|---|---|---|---|
| Surface | | Radius | Thickness | Index (N) | Number (v) | Diameter |
| Stop | | Infinity | 0.000 | — | — | 4.98 |
| ML1 | R1 | 6.778 | 3.000 | 1.55 | 75.5 | 4.98 |
| | R2 | 187.947 | 2.100 | | | 4.7 |
| ML2 | R1 | −44.611 | 0.770 | 1.66 | 20.4 | 3.805 |
| | R2 | 16.943 | 1.500 | | | 3.563 |
| ML3 | R1 | 4.907 | 1.300 | 1.54 | 56 | 3.1 |
| | R2 | 3.210 | 1.900 | | | 2.6 |
| ML4 | R1 | 8.269 | 1.300 | 1.66 | 20.4 | 2.6 |
| | R2 | 13.241 | 1.400 | | | 2.52 |
| FL1 | R1 | 36.041 | 0.820 | 1.54 | 56 | 2.343 |
| | R2 | −35.900 | 0.270 | | | 2.343 |
| FL2 | R1 | −49.584 | 0.700 | 1.57 | 37.4 | 2.343 |
| | R2 | −78.256 | 0.080 | | | 2.343 |
| FL3 | R1 | −45.623 | 0.280 | 1.54 | 56 | 2.343 |
| | R2 | 27.890 | 0.800 | | | 2.343 |
| Optical | R1 | Infinity | 5.380 | 1.52 | 64.2 | |
| Glass | R2 | | 0.210 | | | |

Table 2 shows the aspheric coefficients for each of the optical surfaces of the low refractive inner focusing lens system, wherein numbers 2, 4, . . . , 10 represent the higher order aspheric coefficients. The equation of the aspheric surface profiles is expressed as follows:

$$X ( Y ) = \frac{( \frac{{Y}^{2}}{R} )}{1 + \sqrt{1 - \frac{( 1 + k ) * {Y}^{2}}{{R}^{2}}}} + {\sum }_{i} {A}_{i} * {Y}^{i}$$

wherein:
X: the height of a point on the aspheric surface at a distance Y from the optical axis relative to the tangential plane at the aspheric surface vertex;
Y: the distance from a point on the curve of the aspheric surface to the optical axis;
k: the conic coefficient;
Aᵢ: the aspheric coefficient of order i.

TABLE 2
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −1.5314E−03 | 8.1755E−05 | −1.3324E−06 | −2.9147E−08 |
| | R2 | 0.0000E+00 | 0.0000E+00 | −2.1355E−03 | 8.3137E−05 | 2.0290E−06 | −2.2153E−07 |
| ML3 | R1 | 0.0000E+00 | 0.0000E+00 | −4.5968E−03 | −2.6880E−04 | 3.3444E−05 | −1.6134E−06 |
| | R2 | 0.0000E+00 | 0.0000E+00 | −6.2746E−03 | −5.3119E−04 | 6.4855E−05 | −4.8974E−06 |
| ML4 | R1 | 0.0000E+00 | 0.0000E+00 | 5.3660E−04 | −1.2918E−04 | 2.3182E−05 | 4.9570E−07 |
| | R2 | 0.0000E+00 | 0.0000E+00 | 8.3081E−04 | −1.6397E−04 | 2.7658E−05 | 4.1227E−07 |
| FL1 | R1 | 0.0000E+00 | 0.0000E+00 | −1.6406E−04 | −3.1024E−04 | 7.2155E−05 | −4.0703E−06 |
| | R2 | 0.0000E+00 | 0.0000E+00 | 1.7541E−03 | −1.2704E−03 | 2.7115E−04 | −1.9255E−05 |
| FL2 | R1 | 0.0000E+00 | 0.0000E+00 | 3.9555E−03 | −1.3669E−03 | 2.2710E−04 | −1.9255E−05 |
| | R2 | 0.0000E+00 | 0.0000E+00 | 2.8930E−03 | −1.2743E−03 | 1.6924E−04 | 5.0000E−06 |
| FL3 | R1 | 0.0000E+00 | 0.0000E+00 | 7.8417E−04 | −1.1514E−03 | 2.5461E−04 | 0.0000E+00 |
| | R2 | 0.0000E+00 | 0.0000E+00 | −2.0167E−04 | −1.5010E−04 | 7.1981E−05 | 0.0000E+00 |

FIG. 1C shows a comparison of longitudinal spherical aberration of the main imaging lens and a combination of the main imaging lens and the focusing lens unit in accordance with the first embodiment of the present disclosure. The comparison shows that the aberration of the main imaging lens only is almost unaffected by adding the focusing lens unit.

FIG. 1D shows a comparison of an astigmatic field of the main imaging lens and a combination of the main imaging lens and the focusing lens unit of the present disclosure in accordance with the first embodiment. The comparison shows that the astigmatic field of the main imaging lens only is almost unaffected by adding the focusing lens unit.

FIG. 1E shows a comparison of distortion of a main imaging lens and a combination of the main imaging lens and a focusing lens unit of the present disclosure in accordance with a first embodiment. The comparison shows that the distortion of the main imaging lens only is almost unaffected by adding the focusing lens unit.

### Second Embodiment

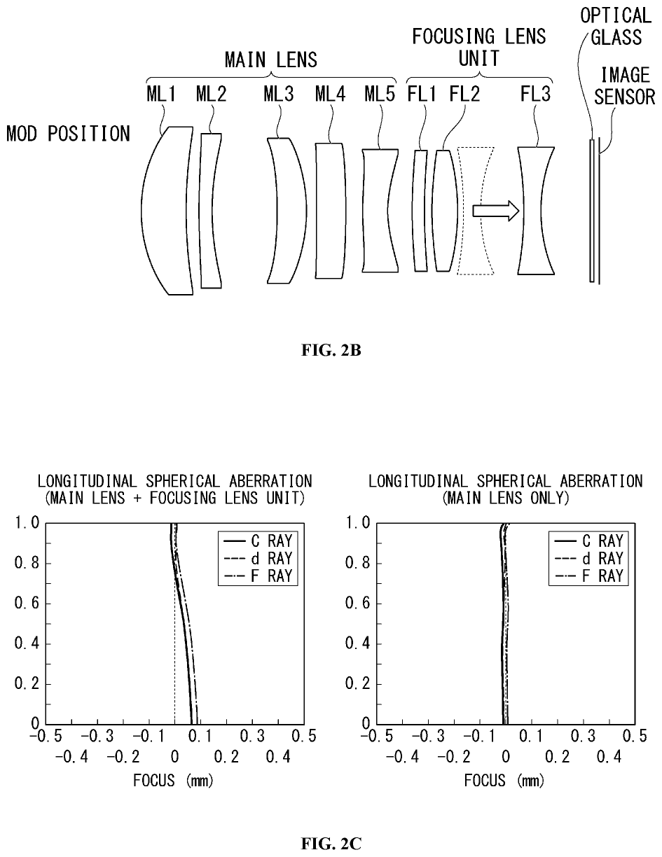

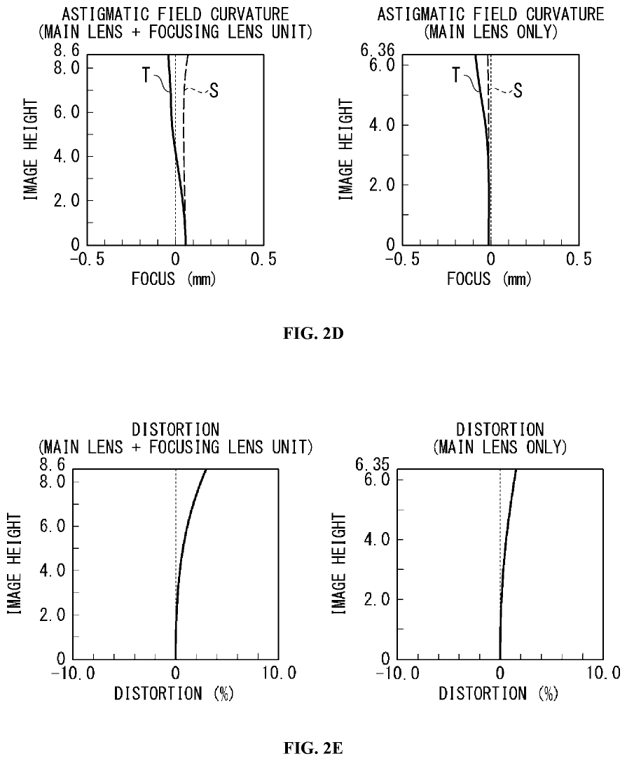

FIG. 2A shows a cross-sectional illustration of an optical lens system in accordance with a second embodiment of the present disclosure at the infinity lens position. A main imaging lens comprises lens elements ML1, ML2, ML3, ML4, and ML5, and a focusing unit comprises lens elements FL1, FL2, and FL3. In the focusing lens unit of this embodiment, a first positive lens group consists of FL1 and FL2, and a second negative lens group consists of FL3.

FIG. 2B shows a cross-sectional illustration of the optical lens system in accordance with the second embodiment of the present disclosure at the MOD lens position. The facing lens surfaces between FL2 and FL3 have substantially corresponding surfaces.

FIGS. 2A and 2B show that only lens element FL3 of the focusing lens unit is moved towards the image side to focus a shorter focal length, and towards the object side to focus at infinity focal length. Therefore, the focus mechanism can be easily designed.

Table 3 shows the radius of curvature (r) and the thickness or separation (d) for each of the optical surfaces, and the refractive index (N), the Abbe number (v), and the effective diameter (φ) for each of the lens elements of the low refractive power inner lens focusing system of the second embodiment.

TABLE 3

| | | | | Refractive | Abbe | Effective |
|---|---|---|---|---|---|---|
| Surface | | Radius | Thickness | Index (N) | Number (v) | Diameter |
| Stop | | Infinity | 0.100 | — | — | 4.6 |
| ML1 | R1 | 7.874 | 2.480 | 1.62 | 63.9 | 4.6 |
| | R2 | 27.416 | 0.700 | | | 4.54 |
| ML2 | R1 | 30.000 | 0.720 | 1.66 | 20.4 | 4.23 |
| | R2 | 12.225 | 3.600 | | | 4.1 |
| ML3 | R1 | −18.887 | 1.620 | 1.54 | 56.0 | 3.86 |
| | R2 | −7.934 | 0.530 | | | 3.98 |
| ML4 | R1 | −100.000 | 1.620 | 1.63 | 24.0 | 3.71 |
| | R2 | −41.749 | 0.920 | | | 3.64 |
| ML5 | R1 | 15.929 | 1.380 | 1.54 | 56.0 | 3.39 |
| | R2 | 5.778 | 1.352 | | | 3.24 |
| FL1 | R1 | 32.694 | 0.668 | 1.57 | 37.4 | 3.33 |
| | R2 | 25.526 | 0.410 | | | 3.33 |
| FL2 | R1 | 15.348 | 1.425 | 1.54 | 56.0 | 3.33 |
| | R2 | −13.726 | 0.32 | | | 3.33 |
| FL3 | R1 | −25.655 | 0.932 | 1.54 | 56.0 | 3.51 |
| | R2 | 7.288 | 6.05 | | | 3.51 |
| Optical | R1 | Infinity | 0.210 | 1.52 | 64.2 | 3.94 |
| Glass | R2 | | 0.300 | | | 3.96 |

Table 4 shows the aspheric coefficients for each of the optical surfaces of the low refractive power focusing lens system, wherein numbers 2, 4, . . . , 10 represent the higher order aspheric coefficients.

TABLE 4
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −6.5967E−04 | 5.1586E−06 | 0.0000E+00 | 0.0000E+00 |
| | R2 | 0.0000E+00 | 0.0000E+00 | −5.8731E−04 | −3.3237E−06 | 0.0000E+00 | 0.0000E+00 |
| ML3 | R1 | 0.0000E+00 | 0.0000E+00 | −2.2866E−06 | −2.1167E−05 | −5.5882E−07 | −3.6651E−08 |
| | R2 | 0.0000E+00 | 0.0000E+00 | 1.5534E−03 | −7.1836E−05 | −4.8192E−07 | 1.9146E−08 |
| ML4 | R1 | 0.0000E+00 | 0.0000E+00 | 1.2440E−03 | −6.6466E−05 | −1.6360E−06 | 3.0413E−08 |
| | R2 | 0.0000E+00 | 0.0000E+00 | 3.3482E−04 | −5.6379E−05 | 2.6460E−06 | −1.2587E−07 |
| ML5 | R1 | 0.0000E+00 | 0.0000E+00 | −3.3704E−03 | −2.9622E−05 | 1.3311E−05 | −5.7769E−07 |
| | R2 | 0.0000E+00 | 0.0000E+00 | −4.8228E−03 | 1.1628E−04 | 1.5706E−06 | −2.2872E−07 |
| FL1 | R1 | 0.0000E+00 | 0.0000E+00 | 1.4197E−03 | −2.3525E−04 | 8.3504E−06 | 0.0000E+00 |
| | R2 | 0.0000E+00 | 0.0000E+00 | −8.1665E−05 | −1.5742E−05 | −1.9447E−06 | 0.0000E+00 |
| FL2 | R1 | 0.0000E+00 | 0.0000E+00 | −3.2600E−03 | 4.1566E−04 | −1.6683E−05 | 0.0000E+00 |
| | R2 | 0.0000E+00 | 0.0000E+00 | −1.5526E−03 | 1.6462E−04 | −4.2838E−06 | 0.0000E+00 |
| FL3 | R1 | 0.0000E+00 | 0.0000E+00 | −8.7375E−04 | −5.7476E−05 | 6.2852E−06 | 0.0000E+00 |
| | R2 | 0.0000E+00 | 0.0000E+00 | −1.3885E−03 | 3.2645E−05 | 6.7827E−07 | 0.0000E+00 |

FIG. 2C shows a comparison of longitudinal spherical aberration of the main imaging lens and a combination of the main imaging lens and the focusing lens unit in accordance with the second embodiment of the present disclosure. The comparison shows that the aberration of the main imaging lens only is almost unaffected by adding the focusing lens unit.

FIG. 2D shows a comparison of an astigmatic field of the main imaging lens and a combination of the main imaging lens and the focusing lens unit of the present disclosure in accordance with the second embodiment. The comparison shows that the astigmatic field of the main imaging lens only is almost unaffected by adding the focusing lens unit.

FIG. 2E shows a comparison of distortion of the main imaging lens and a combination of the main imaging lens and the focusing lens unit of the present disclosure in accordance with the second embodiment. The comparison shows that the distortion of the main imaging lens only is almost unaffected by adding the focusing lens unit.

### Third Embodiment

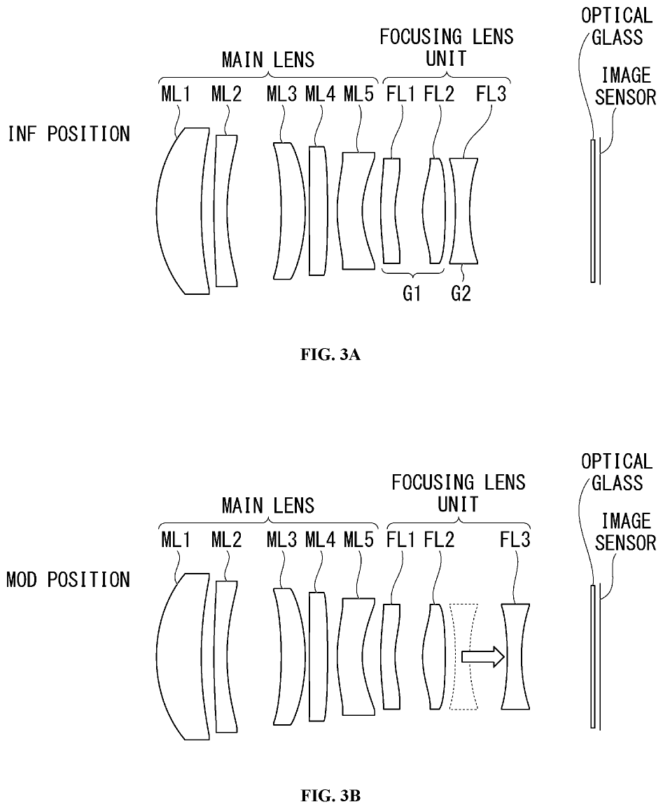

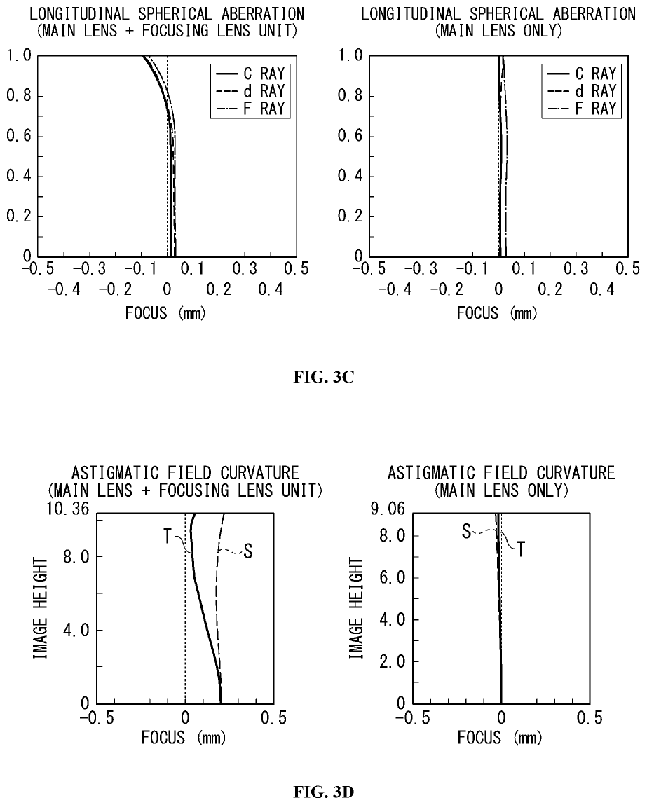

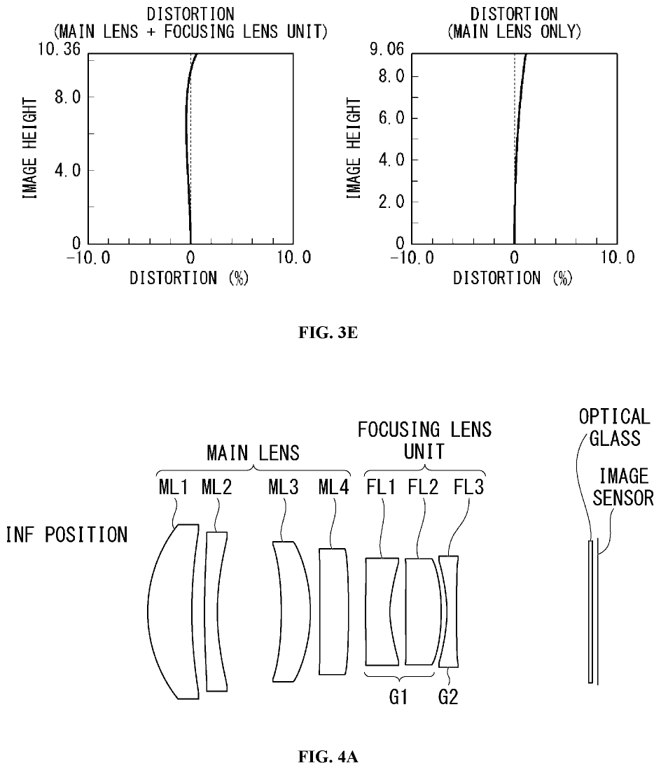

FIG. 3A shows a cross-sectional illustration of an optical lens system in accordance with a third embodiment of the present disclosure at the infinity lens position. A main imaging lens comprises lens elements ML1, ML2, ML3, ML4, and ML5, and a focusing unit comprises lens elements FL1, FL2, and FL3. In the focusing lens unit of this embodiment, a first positive lens group consists of FL1 and FL2, and a second negative lens group consists of FL3.

FIG. 3B shows a cross-sectional illustration of the optical lens system in accordance with a third embodiment of the present disclosure at the MOD lens position. The facing lens surfaces between FL2 and FL3 have substantially corresponding surfaces.

FIGS. 3A and 3B show that only lens element FL3 of the focusing lens unit is moved towards the image side to focus a shorter focal length, and towards the object side to focus at infinity focal length. Therefore, the focus mechanism can be easily designed.

Table 5 shows the radius of curvature (r) and the thickness or separation (d) for each of the optical surfaces, and the refractive index (N), the Abbe number (v), and the effective diameter (φ) for each of the lens elements of the low refractive power lens focusing system of the third embodiment.

TABLE 5

| | | | Thick- | Refractive | Abbe | Effective |
|---|---|---|---|---|---|---|
| Surface | | Radius | ness | Index (N) | Number (v) | Diameter |
| Stop | | Infinity | 0.100 | — | — | 4.6 |
| ML1 | R1 | 7.503 | 2.480 | 1.62 | 63.9 | 4.6 |
| | R2 | 21.845 | 0.700 | | | 4.28 |
| ML2 | R1 | 30.000 | 0.720 | 1.66 | 20.4 | 4.17 |
| | R2 | 11.372 | 3.000 | | | 3.99 |
| ML3 | R1 | −17.859 | 1.320 | 1.54 | 56.0 | 3.73 |
| | R2 | −8.555 | 0.230 | | | 3.77 |
| ML4 | R1 | −100.000 | 1.020 | 1.63 | 24.0 | 3.55 |
| | R2 | −38.980 | 0.520 | | | 3.48 |
| ML5 | R1 | 7.243 | 1.380 | 1.54 | 56.0 | 3.21 |
| | R2 | 4.398 | 1.000 | | | 2.94 |
| FL1 | R1 | 7.300 | 0.810 | 1.57 | 37.4 | 2.9 |
| | R2 | 4.510 | 1.530 | | | 2.9 |
| FL2 | R1 | 4.982 | 1.260 | 1.54 | 56.0 | 2.9 |
| | R2 | −33.024 | 0.55 | | | 2.9 |
| FL3 | R1 | −25.000 | 0.780 | 1.54 | 56.0 | 2.9 |
| | R2 | 6.779 | 6.70 | | | 2.9 |
| Optical | R1 | Infinity | 0.210 | 1.52 | 64.2 | 3.93 |
| Glass | R2 | | 0.300 | | | 3.95 |

Table 6 shows the aspheric coefficients for each of the optical surfaces of the low deflective power focusing system, wherein numbers 2, 4, . . . , 10 represent the higher order aspheric coefficients.

TABLE 6
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −6.4329E−04 | 5.9220E−06 | 0.0000E+00 | 0.0000E+00 |
| | R2 | 0.0000E+00 | 0.0000E+00 | −5.6583E−04 | −5.1851E−06 | 0.0000E+00 | 0.0000E+00 |
| ML3 | R1 | 0.0000E+00 | 0.0000E+00 | 2.4274E−04 | −3.6818E−05 | 8.1068E−07 | −5.8455E−08 |
| | R2 | 0.0000E+00 | 0.0000E+00 | 1.4934E−03 | −6.4590E−05 | −1.3178E−07 | 9.7179E−10 |
| ML4 | R1 | 0.0000E+00 | 0.0000E+00 | 1.4969E−03 | −7.0950E−05 | −1.9288E−06 | 3.1383E−08 |
| | R2 | 0.0000E+00 | 0.0000E+00 | 5.2639E−04 | −6.7557E−05 | 1.8826E−06 | −7.4157E−08 |
| ML5 | R1 | 0.0000E+00 | 0.0000E+00 | −4.2427E−03 | −4.8065E−05 | 1.1113E−05 | −4.0801E−07 |
| | R2 | 0.0000E+00 | 0.0000E+00 | −6.4281E−03 | 6.6171E−05 | 3.5023E−06 | −4.2194E−07 |
| FL1 | R1 | 0.0000E+00 | 0.0000E+00 | −9.7277E−03 | 4.9318E−04 | −3.7184E−06 | 0.0000E+00 |
| | R2 | 0.0000E+00 | 0.0000E+00 | −1.7631E−02 | 9.0327E−04 | −1.4907E−05 | 0.0000E+00 |
| FL2 | R1 | 0.0000E+00 | 0.0000E+00 | −5.3922E−03 | −3.4384E−04 | 1.8457E−05 | 0.0000E+00 |
| | R2 | 0.0000E+00 | 0.0000E+00 | −8.4145E−04 | −3.2866E−04 | 1.0616E−05 | 0.0000E+00 |
| FL3 | R1 | 0.0000E+00 | 0.0000E+00 | −4.8522E−03 | 4.7999E−04 | −1.7227E−05 | 0.0000E+00 |
| | R2 | 0.0000E+00 | 0.0000E+00 | −5.6489E−03 | 5.1917E−04 | −1.7820E−05 | 0.0000E+00 |

FIG. 3C shows a comparison of longitudinal spherical aberration of the main imaging lens and a combination of the main imaging lens and the focusing lens unit in accordance with the third embodiment of the present disclosure. The comparison shows that the aberration of the main imaging lens only is almost unaffected by adding the focusing lens unit.

FIG. 3D shows a comparison of an astigmatic field of the main imaging lens and a combination of the main imaging lens and the focusing lens unit of the present disclosure in accordance with the third embodiment. The comparison shows that the astigmatic field of the main imaging lens only is almost unaffected by adding the focusing lens unit.

FIG. 3E shows a comparison of distortion of the main imaging lens and a combination of the main imaging lens and the focusing lens unit of the present disclosure in accordance with the third embodiment. The comparison shows that the distortion of the main imaging lens only is almost unaffected by adding the focusing lens unit.

### Fourth Embodiment

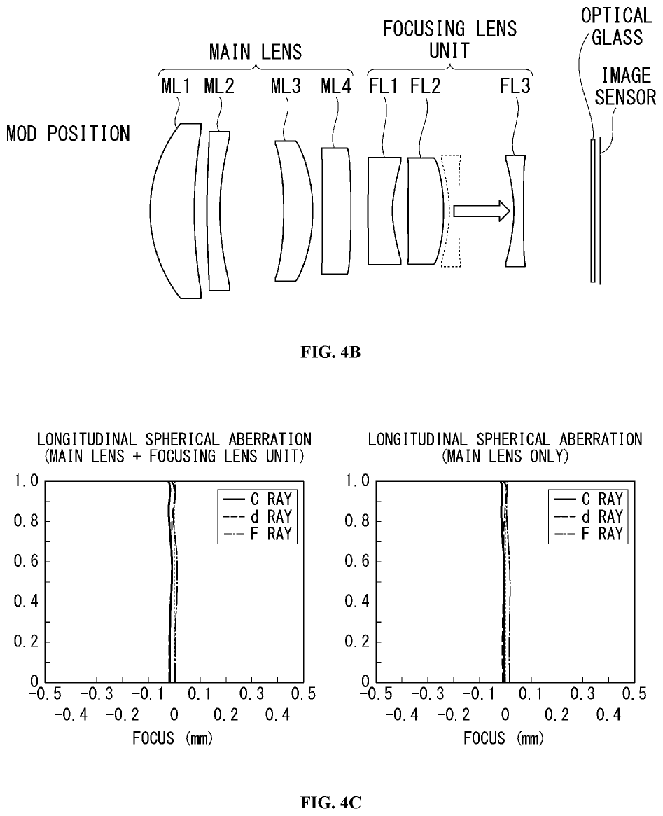

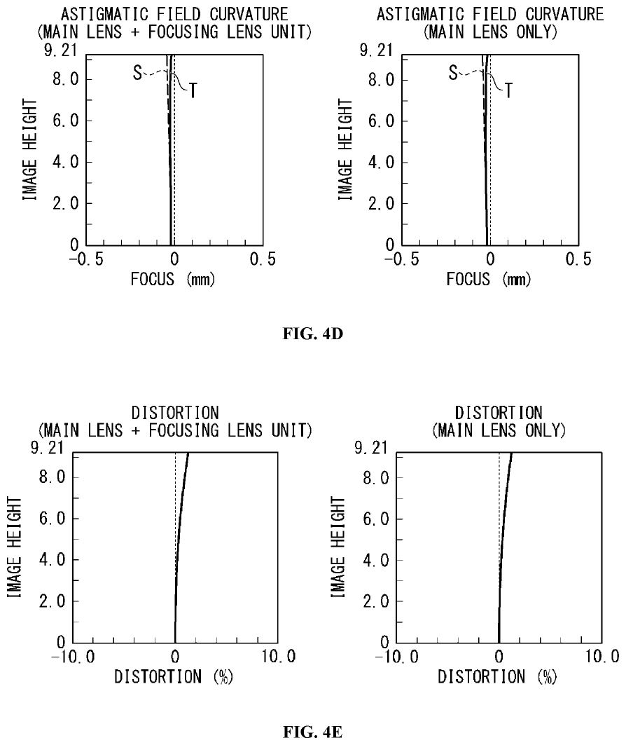

FIG. 4A shows a cross-sectional illustration of an optical lens system in accordance with a fourth embodiment of the present disclosure at the infinity lens position. A main imaging lens comprises lens elements ML1, ML2, ML3, and ML4, and a focusing unit comprises lens elements FL1, FL2, and FL3. In the focusing lens unit of this embodiment, a first positive lens group consists of FL1 and FL2, and a second negative lens group consists of FL3.

FIG. 4B shows a cross-sectional illustration of the optical lens system in accordance with the fourth embodiment of the present disclosure at the MOD lens position. The facing lens surfaces between FL2 and FL3 have substantially corresponding surfaces.

FIGS. 4A and 4B show that only lens element FL3 of the focusing lens unit is moved towards the image side to focus a shorter focal length, and towards the object side to focus at infinity focal length. Therefore, the focus mechanism can be easily designed.

Table 7 shows the radius of curvature (r) and the thickness or separation (d) for each of the optical surfaces, and the refractive index (N), the Abbe number (v), and the effective diameter (φ) for each of the lens elements of the low refractive power inner lens focusing system of the fourth embodiment.

TABLE 7

| | | | Thick- | Refractive | Abbe | Effective |
|---|---|---|---|---|---|---|
| Surface | | Radius | ness | Index (N) | Number (v) | Diameter |
| Stop | | Infinity | 0.100 | — | — | 4.9 |
| ML1 | R1 | 7.874 | 2.480 | 1.62 | 63.9 | 4.9 |
| | R2 | 27.416 | 0.700 | | | 4.61 |
| ML2 | R1 | 30.000 | 0.720 | 1.66 | 20.4 | 4.47 |
| | R2 | 12.225 | 3.600 | | | 4.27 |
| ML3 | R1 | −18.887 | 1.620 | 1.54 | 56.0 | 3.86 |
| | R2 | −7.934 | 0.530 | | | 3.93 |
| ML4 | R1 | −100.000 | 1.620 | 1.63 | 24.0 | 3.53 |
| | R2 | −41.749 | 0.920 | | | 3.34 |
| FL1 | R1 | 15.929 | 1.380 | 1.54 | 56.0 | 3.00 |
| | R2 | 5.778 | 0.890 | | | 3.00 |
| FL2 | R1 | 64.696 | 2.000 | 1.54 | 56.0 | 2.94 |
| | R2 | −9.956 | 0.32 | | | 2.99 |
| FL3 | R1 | −7.013 | 0.540 | 1.54 | 56.0 | 2.99 |
| | R2 | −45.934 | 7.40 | | | 3.12 |
| Optical | R1 | Infinity | 0.210 | 1.52 | 64.2 | — |
| Glass | R2 | | 0.300 | | | |

Table 8 shows the aspheric coefficients for each of the optical surfaces of the low refractive power inner lens focusing system, wherein numbers 2, 4, . . . , 10 represent the higher order aspheric coefficients.

TABLE 8
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −6.5967E−04 | 5.1586E−06 | 0.0000E+00 | 0.0000E+00 |
| | R2 | 0.0000E+00 | 0.0000E+00 | −5.8731E−04 | −3.3237E−06 | 0.0000E+00 | 0.0000E+00 |
| ML3 | R1 | 0.0000E+00 | 0.0000E+00 | −2.2866E−06 | −2.1167E−05 | −5.5882E−07 | −3.6651E−08 |
| | R2 | 0.0000E+00 | 0.0000E+00 | 1.5534E−03 | −7.1836E−05 | −4.8192E−07 | 1.9146E−08 |
| ML4 | R1 | 0.0000E+00 | 0.0000E+00 | 1.2440E−03 | −6.6466E−05 | −1.6360E−06 | 3.0413E−08 |
| | R2 | 0.0000E+00 | 0.0000E+00 | 3.3482E−04 | −5.6379E−05 | 2.6460E−06 | −1.2587E−07 |
| FL1 | R1 | 0.0000E+00 | 0.0000E+00 | −3.3704E−03 | −2.9622E−05 | 1.3311E−05 | −5.7769E−07 |
| | R2 | 0.0000E+00 | 0.0000E+00 | −4.8228E−03 | 1.1628E−04 | 1.5706E−06 | −2.2872E−07 |
| FL2 | R1 | 0.0000E+00 | 0.0000E+00 | −4.9111E−04 | −1.9377E−05 | −1.7416E−06 | 0.0000E+00 |
| | R2 | 0.0000E+00 | 0.0000E+00 | −4.0083E−04 | −2.2264E−05 | −8.0760E−07 | 0.0000E+00 |
| FL3 | R1 | 0.0000E+00 | 0.0000E+00 | 4.6341E−03 | −3.4214E−04 | 1.2813E−05 | 0.0000E+00 |
| | R2 | 0.0000E+00 | 0.0000E+00 | 4.1823E−03 | −3.1262E−04 | 1.0964E−05 | 0.0000E+00 |

FIG. 4C shows a comparison of longitudinal spherical aberration of the main imaging lens and a combination of the main imaging lens and the focusing lens unit in accordance with the fourth embodiment of the present disclosure. The comparison shows that the aberration of the main imaging lens only is almost unaffected by adding the focusing lens unit.

FIG. 4D shows a comparison of an astigmatic field of the main imaging lens and a combination of the main imaging lens and the focusing lens unit of the present disclosure in accordance with the fourth embodiment. The comparison shows that the astigmatic field of the main imaging lens only is almost unaffected by adding the focusing lens unit.

FIG. 4E shows a comparison of distortion of the main imaging lens and a combination of the main imaging lens and the focusing lens unit of the present disclosure in accordance with the fourth embodiment. The comparison shows that the distortion of the main imaging lens only is almost unaffected by adding the focusing lens unit.

### Fifth Embodiment

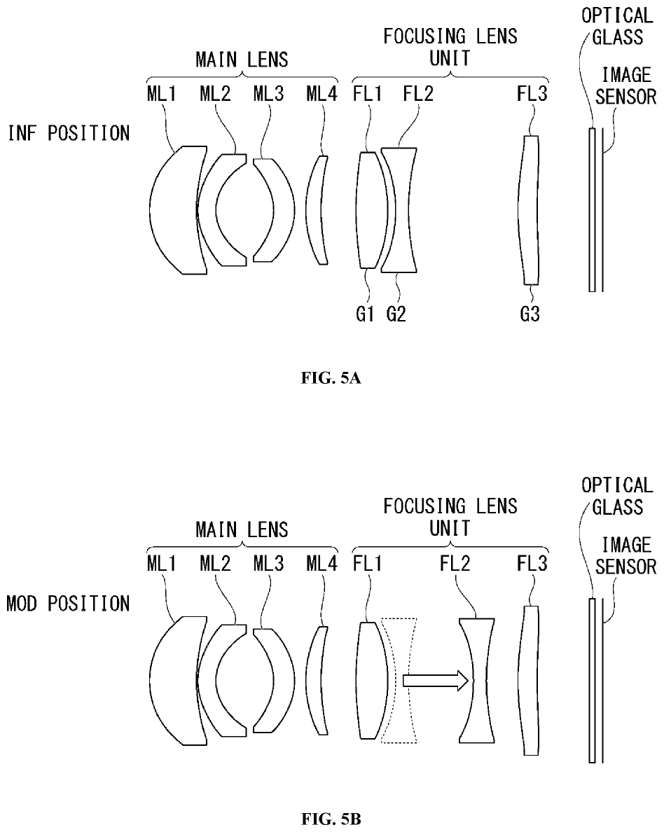

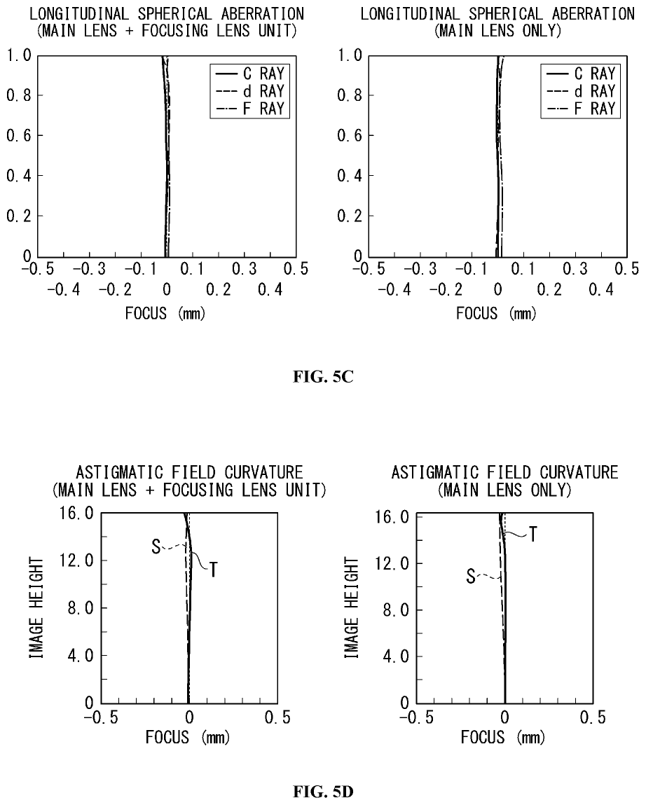

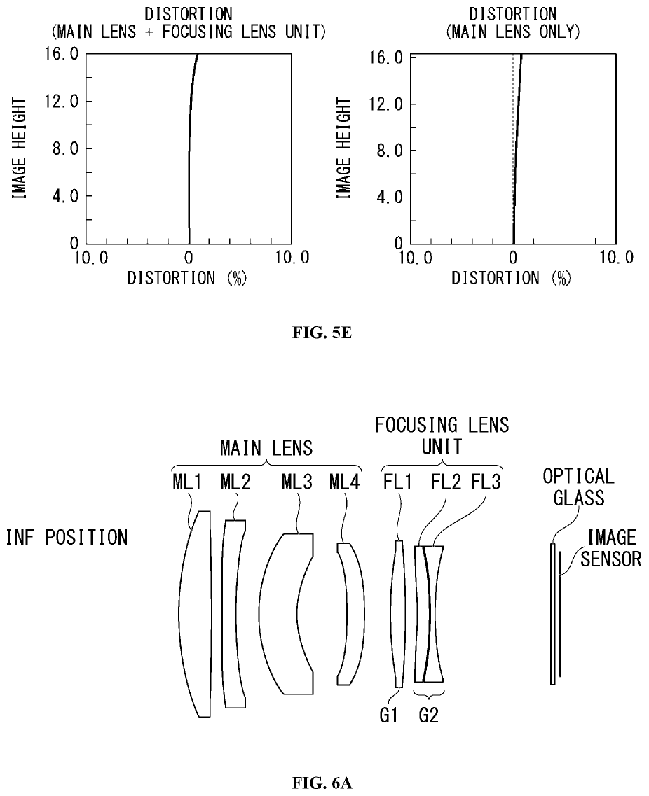

FIG. 5A shows a cross-sectional illustration of an optical lens system in accordance with a fifth embodiment of the present disclosure at the infinity lens position. A main imaging lens comprises lens elements ML1, ML2, ML3, and ML4, and a focusing unit comprises lens elements FL1, FL2, and FL3. In the focusing lens unit of this embodiment, a first positive lens group consists of FL1, a second negative lens group consists of FL2, and a third positive lens group consists of FL3.

FIG. 5B shows a cross-sectional illustration of an optical lens system in accordance with the fifth embodiment of the present disclosure at the MOD lens position. The facing lens surfaces between FL1 and FL2 have substantially corresponding surfaces.

FIGS. 5A and 5B show that only lens element FL2 of the focusing lens unit is moved towards the image side to focus a shorter focal length, and towards the object side to focus at infinity focal length. Therefore, the focus mechanism can be easily designed.

Table 9 shows the radius of curvature (r) and the thickness or separation (d) for each of the optical surfaces, and the refractive index (N), the Abbe number (v), and the effective diameter (φ) for each of the lens elements of the low refractive power inner lens focusing system of the fifth embodiment.

TABLE 9

| | | | Thick- | Refractive | Abbe | Effective |
|---|---|---|---|---|---|---|
| Surface | | Radius | ness | Index (N) | Number (v) | Diameter |
| Stop | | Infinity | 0.000 | — | — | 3.1 |
| ML1 | R1 | 4.437 | 1.770 | 1.62 | 63.9 | 3.1 |
| | R2 | 11.342 | 0.050 | | | 2.86 |
| ML2 | R1 | 4.190 | 0.670 | 1.66 | 20.4 | 2.69 |
| | R2 | 2.789 | 2.150 | | | 2.29 |
| ML3 | R1 | −3.057 | 0.780 | 1.63 | 24.0 | 2.24 |
| | R2 | −3.688 | 0.410 | | | 2.5 |
| ML4 | R1 | 5.471 | 0.590 | 1.54 | 56.0 | 2.6 |
| | R2 | 10.146 | 1.300 | | | 2.6 |
| FL1 | R1 | 19.254 | 1.190 | 1.54 | 56.0 | 2.80 |
| | R2 | −8.679 | 0.30 | | | 2.80 |
| FL2 | R1 | −8.043 | 0.460 | 1.54 | 56.0 | 2.8 |
| | R2 | 11.655 | 4.10 | | | 3 |
| FL3 | R1 | 16.953 | 0.720 | 1.54 | 56.0 | 3.6 |
| | R2 | 38.211 | 1.950 | | | 3.6 |
| Optical | R1 | Infinity | 0.210 | 1.52 | 64.2 | — |
| Glass | R2 | | 0.300 | | | |

Table 10 shows the aspheric coefficients for each of the optical surfaces of the 1 low refractive power inner lens focusing system, wherein numbers 2, 4, . . . , 10 represent the higher order aspheric coefficients.

TABLE 10
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −1.6385E−03 | −3.9881E−05 | 0.0000E+00 | 0.0000E+00 |
| | R2 | 0.0000E+00 | 0.0000E+00 | −1.7266E−03 | −8.8509E−05 | 0.0000E+00 | 0.0000E+00 |
| ML3 | R1 | 0.0000E+00 | 0.0000E+00 | 1.2374E−02 | −1.5482E−03 | 2.5253E−04 | −1.6104E−05 |
| | R2 | 0.0000E+00 | 0.0000E+00 | 5.8931E−03 | −7.7781E−04 | 1.2305E−04 | −8.3602E−06 |
| ML4 | R1 | 0.0000E+00 | 0.0000E+00 | −6.7959E−03 | 4.9247E−04 | −3.2303E−05 | 5.2239E−06 |
| | R2 | 0.0000E+00 | 0.0000E+00 | −4.4122E−03 | 4.1815E−04 | −5.5323E−05 | 7.6319E−06 |
| FL1 | R1 | 0.0000E+00 | 0.0000E+00 | −5.0350E−04 | 1.4996E−05 | −1.0581E−06 | 0.0000E+00 |
| | R2 | 0.0000E+00 | 0.0000E+00 | −2.5480E−04 | −1.5153E−05 | 5.4473E−07 | 0.0000E+00 |
| FL2 | R1 | 0.0000E+00 | 0.0000E+00 | −5.1304E−04 | −3.3352E−05 | 3.8833E−06 | 0.0000E+00 |
| | R2 | 0.0000E+00 | 0.0000E+00 | −1.0503E−03 | 2.3233E−06 | 1.1763E−06 | 0.0000E+00 |
| FL3 | R1 | 0.0000E+00 | 0.0000E+00 | −6.6998E−04 | 3.0891E−05 | −3.5520E−06 | 0.0000E+00 |
| | R2 | 0.0000E+00 | 0.0000E+00 | −8.1860E−04 | 3.6187E−05 | −3.2731E−06 | 0.0000E+00 |

FIG. 5C shows a comparison of longitudinal spherical aberration of the main imaging lens and a combination of the main imaging lens and the focusing lens unit in accordance with the fifth embodiment of the present disclosure. The comparison shows that the aberration of the main imaging lens only is almost unaffected by adding the focusing lens unit.

FIG. 5D shows a comparison of an astigmatic field of the main imaging lens and a combination of the main imaging lens and the focusing lens unit of the present disclosure in accordance with the fifth embodiment. The comparison shows that the astigmatic field of the main imaging lens only is almost unaffected by adding the focusing lens unit.

FIG. 5E shows a comparison of distortion of the main imaging lens and a combination of the main imaging lens and the focusing lens unit of the present disclosure in accordance with the fifth embodiment. The comparison shows that the distortion of the main imaging lens only is almost unaffected by adding the focusing lens unit.

### Sixth Embodiment

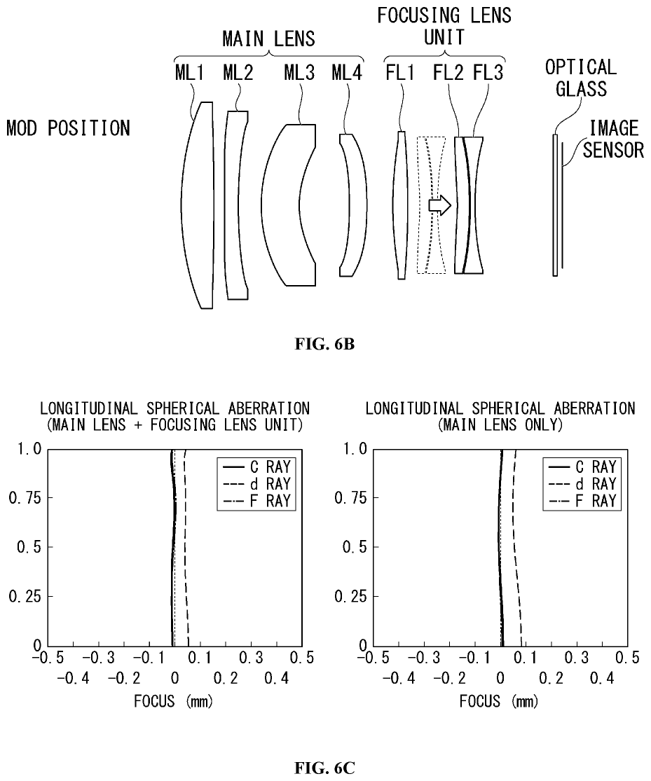

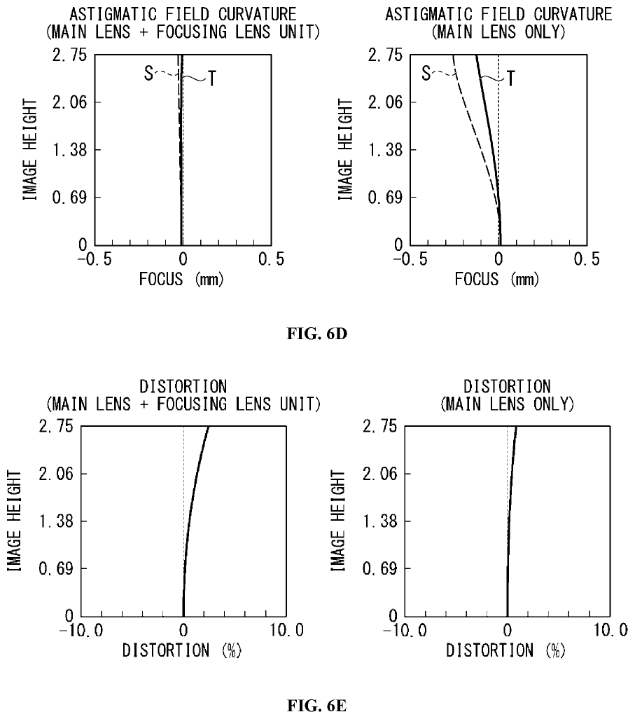

FIG. 6A shows a cross-sectional illustration of an optical lens system in accordance with a sixth embodiment of the present disclosure at the infinity lens position. A main imaging lens comprises lens elements ML1, ML2, ML3, and ML4, and a focusing unit comprises lens elements FL1, FL2, and FL3. In the focusing lens unit of this embodiment, a first positive lens group consists of FL1, and a second negative lens group consists of FL2 and FL3.

FIG. 6B shows a cross-sectional illustration of the optical lens system in accordance with the sixth embodiment of the present disclosure at the MOD lens position. The facing lens surfaces between FL1 and FL2 have substantially corresponding surfaces.

FIGS. 6A and 6B show that only lens elements FL2 and FL3 of the focusing lens unit are moved towards the image side to focus a shorter focal length, and towards the object side to focus at infinity focal length. Therefore, the focus mechanism can be easily designed.

Table 11 shows the radius of curvature (r) and the thickness or separation (d) for each of the optical surfaces, and the refractive index (N), the Abbe number (v), and the effective diameter (φ) for each of the lens elements of the low refractive power inner lens focusing system of the sixth embodiment.

TABLE 11

| | | | Thick- | Refractive | Abbe | Effective |
|---|---|---|---|---|---|---|
| Surface | | Radius | ness | Index (N) | Number (v) | Diameter |
| Stop | | Infinity | 0.000 | — | — | 4 |
| ML1 | R1 | 9.309 | 1.843 | 1.55 | 75.5 | 4.00 |
| | R2 | −148.038 | 0.587 | | | 3.86 |
| ML2 | R1 | 1853.138 | 0.800 | 1.66 | 20.4 | 3.64 |
| | R2 | 18.016 | 1.255 | | | 3.40 |
| ML3 | R1 | 4.170 | 2.199 | 1.54 | 55.7 | 3.14 |
| | R2 | 3.409 | 2.839 | | | 2.50 |
| ML4 | R1 | −9.126 | 0.978 | 1.57 | 37.3 | 2.55 |
| | R2 | −7.247 | 1.445 | | | 2.75 |
| FL1 | R1 | 14.043 | 0.824 | 1.54 | 55.9 | 2.84 |
| | R2 | −28.659 | 0.65 | | | 2.82 |
| FL2 | R1 | −28.659 | 0.700 | 1.57 | 37.3 | 2.67 |
| | R2 | −12.879 | 0.030 | | | 2.67 |
| FL3 | R1 | −12.879 | 0.282 | 1.54 | 55.9 | 2.67 |
| | R2 | 9.378 | 6.538 | | | 2.67 |
| Optical | R1 | Infinity | 0.210 | 51.68 | 64.17 | 2.73 |
| Glass | R2 | | 0.320 | | | |

Table 12 shows the aspheric coefficients for each of the optical surfaces of the low refractive power inner lens focusing system, wherein numbers 2, 4, . . . , 10 represent the higher order aspheric coefficients.

TABLE 12
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | 1.2421E−03 | −3.9461E−05 | 1.5188E−06 | −3.1662E−08 |
| | R2 | 0.0000E+00 | 0.0000E+00 | 9.5291E−04 | −1.0153E−05 | 1.5505E−06 | −1.9178E−08 |
| ML3 | R1 | 0.0000E+00 | 0.0000E+00 | −1.8083E−03 | −8.1852E−05 | −3.3005E−07 | 0.0000E+00 |
| | R2 | 0.0000E+00 | 0.0000E+00 | −2.2827E−03 | −3.8626E−04 | −1.0272E−05 | 0.0000E+00 |
| ML4 | R1 | 0.0000E+00 | 0.0000E+00 | −1.2950E−03 | −3.0619E−04 | −4.1308E−06 | 0.0000E+00 |
| | R2 | 0.0000E+00 | 0.0000E+00 | −1.0559E−03 | −1.2594E−04 | 8.2873E−07 | 0.0000E+00 |
| FL1 | R1 | 0.0000E+00 | 0.0000E+00 | −1.0027E−04 | 9.3618E−05 | −1.0598E−05 | 0.0000E+00 |
| | R2 | 0.0000E+00 | 0.0000E+00 | 4.0708E−04 | −1.8444E−05 | −2.9745E−06 | 0.0000E+00 |
| FL2 | R1 | 0.0000E+00 | 0.0000E+00 | 4.0708E−04 | −1.8444E−05 | −2.9745E−06 | 0.0000E+00 |
| | R2 | 0.0000E+00 | 0.0000E+00 | 1.5967E−03 | −2.6061E−04 | 0.0000E+00 | 0.0000E+00 |
| FL3 | R1 | 0.0000E+00 | 0.0000E+00 | 1.5967E−03 | −2.6061E−04 | 0.0000E+00 | 0.0000E+00 |
| | R2 | 0.0000E+00 | 0.0000E+00 | 3.8723E−04 | 1.0755E−04 | −1.2776E−05 | 0.0000E+00 |

FIG. 6C shows a comparison of longitudinal spherical aberration of the main imaging lens and a combination of the main imaging lens and the focusing lens unit in accordance with the sixth embodiment of the present disclosure. The comparison shows that the aberration of the main imaging lens only is almost unaffected by adding the focusing lens unit.

FIG. 6D shows a comparison of an astigmatic field of the main imaging lens and a combination of the main imaging lens and the focusing lens unit of the present disclosure in accordance with the sixth embodiment. The comparison shows that the astigmatic field of the main imaging lens only is almost unaffected by adding the focusing lens unit.

FIG. 6E shows a comparison of distortion of the main imaging lens and a combination of the main imaging lens and the focusing lens unit of the present disclosure in accordance with the sixth embodiment. The comparison shows that the distortion of the main imaging lens only is almost unaffected by adding the focusing lens unit.

### Seventh Embodiment

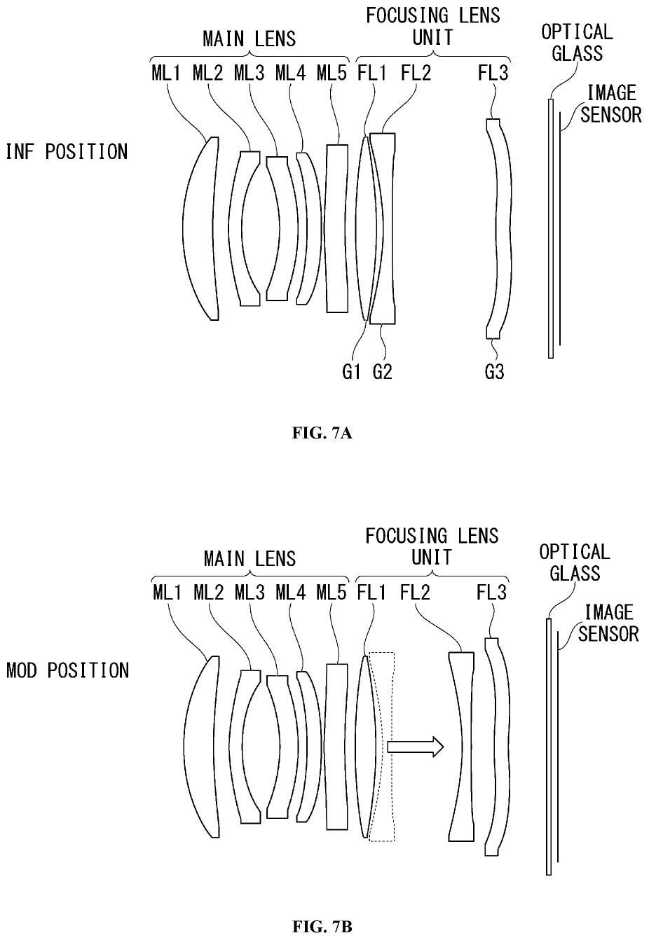

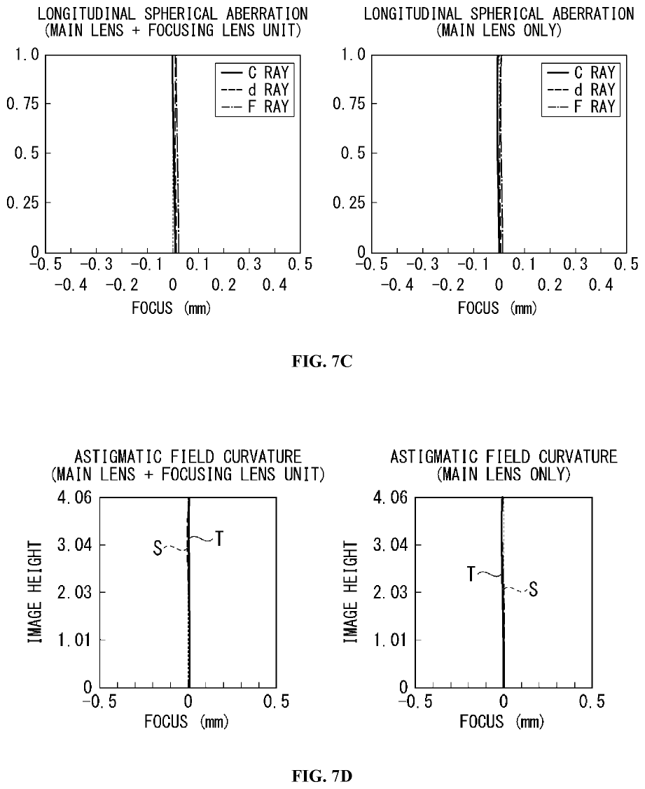

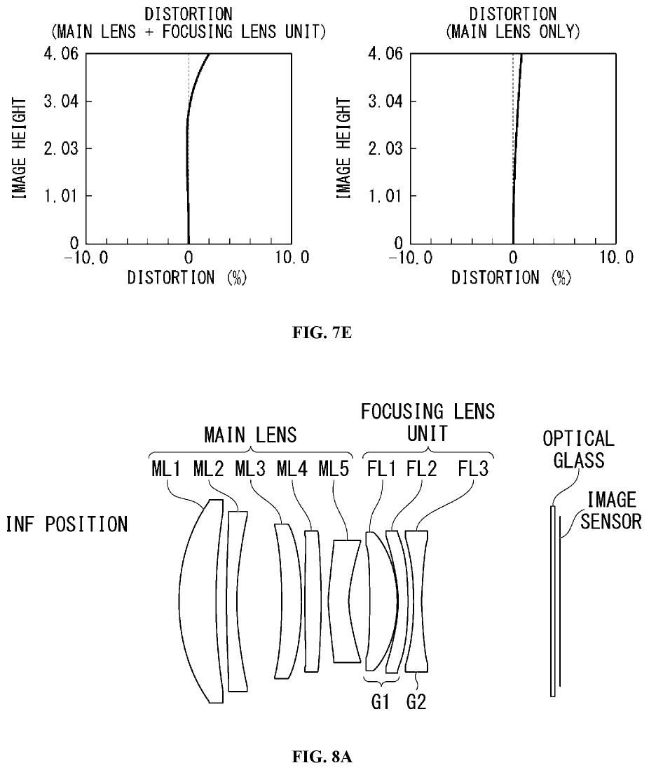

FIG. 7A shows a cross-sectional illustration of an optical lens system in accordance with a seventh embodiment of the present disclosure at the infinity lens position. A main imaging lens comprises lens elements ML1, ML2, ML3, ML4, and ML5, and a focusing unit comprises lens elements FL1, FL2, and FL3. In the focusing lens unit of this embodiment, a first positive lens group consists of FL1, a second negative lens group consists of FL2, and a third negative lens group consists of FL3.

FIG. 7B shows a cross-sectional illustration of the optical lens system in accordance with the seventh embodiment of the present disclosure at the MOD lens position. The facing lens surfaces between FL1 and FL2 have substantially corresponding surfaces.

FIGS. 7A and 7B show that only lens element FL1 of the focusing lens unit is moved towards the image side to focus a shorter focal length, and towards the object side to focus at infinity focal length. Therefore, the focus mechanism can be easily designed.

Table 13 shows the radius of curvature (r) and the thickness or separation (d) for each of the optical surfaces, and the refractive index (N), the Abbe number (v), and the effective diameter (φ) for each of the lens elements of the low refractive power inner lens focusing system of the seventh embodiment.

TABLE 13

| | | | Thick- | Refractive | Abbe | Effective |
|---|---|---|---|---|---|---|
| Surface | | Radius | ness | Index (N) | Number (v) | Diameter |
| Stop | | Infinity | 0.000 | — | — | 4 |
| ML1 | R1 | 4.409 | 1.390 | 1.62 | 63.9 | 2.83 |
| | R2 | 19.008 | 0.708 | | | 2.70 |
| ML2 | R1 | 5.586 | 0.550 | 1.66 | 20.4 | 2.39 |
| | R2 | 3.286 | 1.746 | | | 2.12 |
| ML3 | R1 | −3.233 | 0.838 | 1.54 | 55.7 | 2.10 |
| | R2 | −3.647 | 0.384 | | | 2.22 |
| ML4 | R1 | −6.027 | 0.670 | 1.57 | 37.3 | 2.24 |
| | R2 | −5.552 | 0.100 | | | 2.35 |
| ML5 | R1 | 8.242 | 0.920 | 1.54 | 55.9 | 2.48 |
| | R2 | 7.970 | 0.500 | | | 2.59 |
| FL1 | R1 | 14.332 | 0.930 | 1.54 | 55.9 | 2.85 |
| | R2 | −11.601 | 0.30 | | | 2.70 |
| FL2 | R1 | −6.478 | 0.400 | 1.54 | 55.9 | 2.80 |
| | R2 | 61.532 | 4.70 | | | 2.95 |
| FL3 | R1 | 16.822 | 0.650 | 1.57 | 37.3 | 3.39 |
| | R2 | 15.418 | 1.705 | | | 3.57 |
| Optical | R1 | Infinity | 0.210 | 1.5168 | 64.17 | — |
| Glass | R2 | | 0.300 | | | |

Table 14 shows the aspheric coefficients for each of the optical surfaces of the 1 low refractive power inner lens focusing system, wherein numbers 2, 4, . . . , 10 represent the higher order aspheric coefficients.

TABLE 14
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −2.1085E−03 | −3.8291E−05 | 4.2958E−06 | 0.0000E+00 |
| | R2 | 0.0000E+00 | 0.0000E+00 | −1.4964E−03 | −5.2448E−05 | −3.5676E−06 | 0.0000E+00 |
| ML3 | R1 | 0.0000E+00 | 0.0000E+00 | 1.2535E−02 | −6.9186E−04 | 1.0893E−05 | 1.1020E−05 |
| | R2 | 0.0000E+00 | 0.0000E+00 | 1.4278E−02 | −1.0535E−03 | −1.3193E−05 | 1.4323E−05 |
| ML4 | R1 | 0.0000E+00 | 0.0000E+00 | 9.2967E−03 | −1.2940E−03 | −3.8860E−05 | 5.7786E−07 |
| | R2 | 0.0000E+00 | 0.0000E+00 | 3.6966E−03 | −1.7622E−04 | −1.3196E−04 | 7.4191E−06 |
| ML5 | R1 | 0.0000E+00 | 0.0000E+00 | −8.9773E−03 | 6.4129E−04 | −8.4655E−05 | 6.9761E−06 |
| | R2 | 0.0000E+00 | 0.0000E+00 | −1.0082E−02 | 8.3225E−04 | −7.1866E−05 | 3.6605E−06 |
| FL1 | R1 | 0.0000E+00 | 0.0000E+00 | 1.6766E−04 | −3.6322E−05 | 6.2274E−06 | 0.0000E+00 |
| | R2 | 0.0000E+00 | 0.0000E+00 | −1.6465E−05 | −3.8801E−05 | 6.8414E−06 | 0.0000E+00 |
| FL2 | R1 | 0.0000E+00 | 0.0000E+00 | 3.4219E−03 | −3.1313E−04 | 1.4879E−05 | 0.0000E+00 |
| | R2 | 0.0000E+00 | 0.0000E+00 | 2.4967E−03 | −2.8090E−04 | 1.2079E−05 | 0.0000E+00 |
| FL3 | R1 | 0.0000E+00 | 0.0000E+00 | −7.4055E−03 | 1.7175E−04 | −1.5510E−05 | 9.4321E−07 |
| | R2 | 0.0000E+00 | 0.0000E+00 | −8.2597E−03 | 2.5511E−04 | −1.1837E−05 | 5.9595E−07 |

FIG. 7C shows a comparison of longitudinal spherical aberration of the main imaging lens and a combination of the main imaging lens and the focusing lens unit in accordance with the seventh embodiment of the present disclosure. The comparison shows that the aberration of the main imaging lens only is almost unaffected by adding the focusing lens unit.

FIG. 7D shows a comparison of an astigmatic field of the main imaging lens and a combination of the main imaging lens and the focusing lens unit of the present disclosure in accordance with the seventh embodiment. The comparison shows that the astigmatic field of the main imaging lens only is almost unaffected by adding the focusing lens unit.

FIG. 7E shows a comparison of distortion of the main imaging lens and a combination of the main imaging lens and the focusing lens unit of the present disclosure in accordance with the seventh embodiment. The comparison shows that the distortion of the main imaging lens only is almost unaffected by adding the focusing lens unit.

### Eighth Embodiment

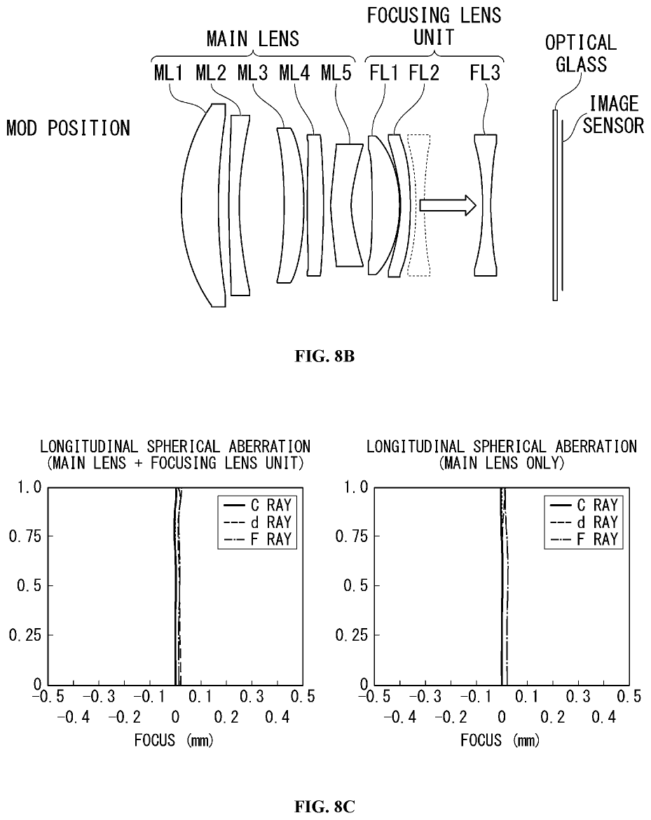

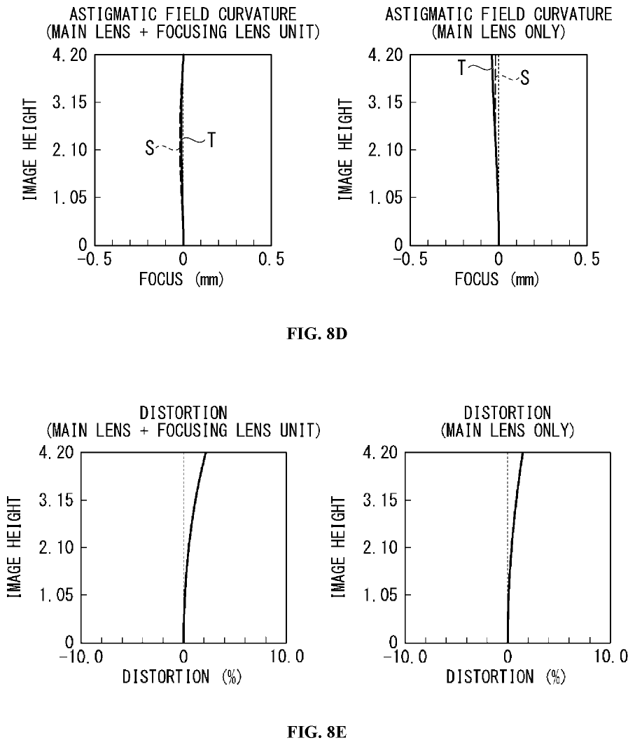

FIG. 8A shows a cross-sectional illustration of an optical lens system in accordance with an eighth embodiment of the present disclosure at the infinity lens position. A main imaging lens comprises lens elements ML1, ML2, ML3, ML4, and ML5, and the focusing unit comprises lens elements FL1, FL2, and FL3. In the focusing lens unit of this embodiment, a first positive lens group consists of FL1 and FL2, and a second negative lens group consists of FL3.

FIG. 8B shows a cross-sectional illustration of the optical lens system in accordance with the eighth embodiment of the present disclosure at the MOD lens position. The facing lens surfaces between FL2 and FL3 have substantially corresponding surfaces.

FIGS. 8A and 8B show that only lens element FL2 of the focusing lens unit is moved towards the image side to focus a shorter focal length, and towards the object side to focus at infinity focal length. Therefore, the focus mechanism can be easily designed.

Table 15 shows the radius of curvature (r) and the thickness or separation (d) for each of the optical surfaces, and the refractive index (N), the Abbe number (v), and the effective diameter (φ) for each of the lens elements of the low refractive power inner lens focusing system of the eighth embodiment.

TABLE 15

| | | | Thick- | Refractive | Abbe | Effective |
|---|---|---|---|---|---|---|
| Surface | | Radius | ness | Index (N) | Number (v) | Diameter |
| Stop | | Infinity | 0.000 | — | — | 4.4 |
| ML1 | R1 | 6.959 | 2.300 | 1.62 | 63.9 | 4.38 |
| | R2 | 20.259 | 0.649 | | | 4.04 |
| ML2 | R1 | 27.823 | 0.668 | 1.66 | 20.4 | 3.92 |
| | R2 | 10.547 | 2.782 | | | 3.71 |
| ML3 | R1 | −16.563 | 1.224 | 1.54 | 55.9 | 3.33 |
| | R2 | −7.934 | 0.213 | | | 3.32 |
| ML4 | R1 | −92.742 | 0.946 | 1.64 | 23.9 | 3.08 |
| | R2 | −36.151 | 0.482 | | | 2.96 |
| ML5 | R1 | 6.717 | 1.280 | 1.54 | 55.9 | 2.65 |
| | R2 | 4.079 | 1.233 | | | 2.65 |
| FL1 | R1 | 1212.762 | 1.705 | 1.54 | 55.9 | 2.75 |
| | R2 | −5.133 | 0.030 | | | 3.02 |
| FL2 | R1 | −7.118 | 0.680 | 1.57 | 37.3 | 3.01 |
| | R2 | −9.830 | 0.35 | | | 3.10 |
| FL3 | R1 | −8.366 | 0.500 | 1.54 | 55.9 | 2.94 |
| | R2 | 17.613 | 7.97 | | | 3.04 |
| Optical | R1 | Infinity | 0.210 | 1.5168 | 64.17 | — |
| Glass | R2 | | 0.320 | | | |

Table 16 shows the aspheric coefficients for each of the optical surfaces of the 1 low refractive power inner lens focusing system, wherein numbers 2, 4, . . . , 10 represent the higher order aspheric coefficients.

TABLE 16
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −8.0645E−04 | 8.6316E−06 | 0.0000E+00 | 0.0000E+00 |
| | R2 | 0.0000E+00 | 0.0000E+00 | −7.0934E−04 | −7.5575E−06 | 0.0000E+00 | 0.0000E+00 |
| ML3 | R1 | 0.0000E+00 | 0.0000E+00 | 3.0431E−04 | −5.3663E−05 | 1.3738E−06 | −1.1517E−07 |
| | R2 | 0.0000E+00 | 0.0000E+00 | 1.8722E−03 | −9.4142E−05 | −2.2331E−07 | 1.9146E−09 |
| ML4 | R1 | 0.0000E+00 | 0.0000E+00 | 1.8766E−03 | −1.0341E−04 | −3.2685E−06 | 6.1831E−08 |
| | R2 | 0.0000E+00 | 0.0000E+00 | 6.5991E−04 | −9.8466E−05 | 3.1902E−06 | −1.4611E−07 |
| ML5 | R1 | 0.0000E+00 | 0.0000E+00 | −5.3187E−03 | −7.0057E−05 | 1.8831E−05 | −8.0386E−07 |
| | R2 | 0.0000E+00 | 0.0000E+00 | −8.0585E−03 | 9.6447E−05 | 5.9350E−06 | −8.3132E−07 |
| FL1 | R1 | 0.0000E+00 | 0.0000E+00 | −1.6448E−03 | −9.8884E−05 | −2.1499E−06 | −2.7806E−06 |
| | R2 | 0.0000E+00 | 0.0000E+00 | 3.7151E−03 | −9.9897E−04 | 7.3400E−05 | −2.8018E−06 |
| FL2 | R1 | 0.0000E+00 | 0.0000E+00 | 4.0330E−03 | −9.1032E−04 | 6.0240E−05 | −4.1499E−07 |
| | R2 | 0.0000E+00 | 0.0000E+00 | −3.6581E−04 | −1.0100E−06 | −9.2726E−06 | 6.2861E−07 |
| FL3 | R1 | 0.0000E+00 | 0.0000E+00 | 9.0002E−04 | −6.1526E−05 | 6.2099E−06 | 0.0000E+00 |
| | R2 | 0.0000E+00 | 0.0000E+00 | 8.5351E−04 | −6.8194E−05 | 6.2070E−06 | −2.3703E−08 |

FIG. 8C shows a comparison of longitudinal spherical aberration of the main imaging lens and a combination of the main imaging lens and the focusing lens unit in accordance with the eighth embodiment of the present disclosure. The comparison shows that the aberration of the main imaging lens only is almost unaffected by adding the focusing lens unit.

FIG. 8D shows a comparison of an astigmatic field of the main imaging lens and a combination of the main imaging lens and the focusing lens unit of the present disclosure in accordance with the eighth embodiment. The comparison shows that the astigmatic field of the main imaging lens only is almost unaffected by adding the focusing lens unit.

FIG. 8E shows a comparison of distortion of the main imaging lens and a combination of the main imaging lens and the focusing lens unit of the present disclosure in accordance with the eighth embodiment. The comparison shows that the distortion of the main imaging lens only is almost unaffected by adding the focusing lens unit.

### Ninth Embodiment

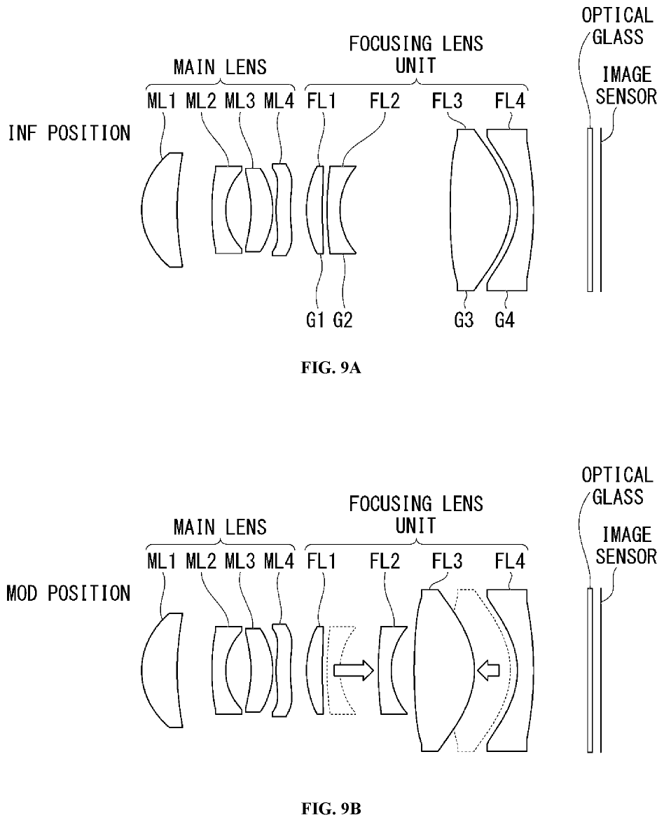

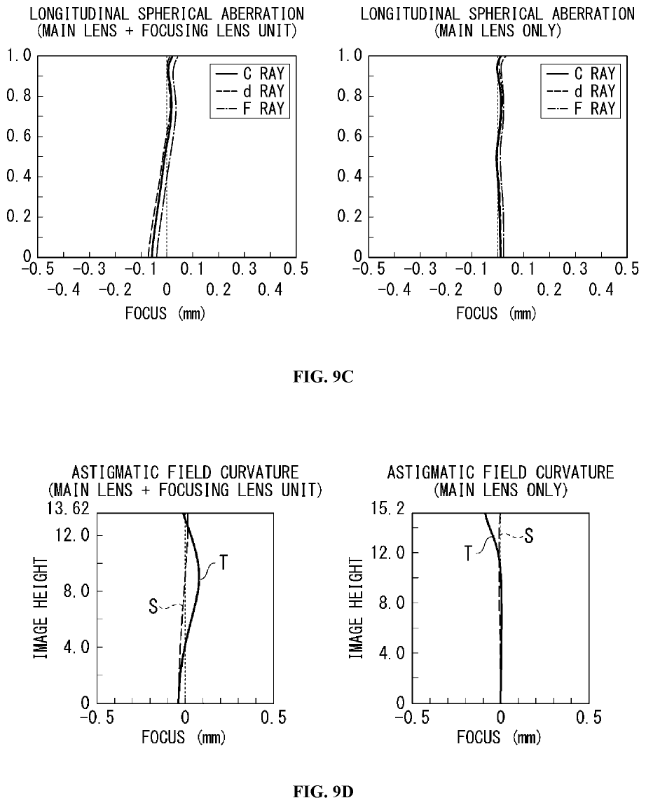

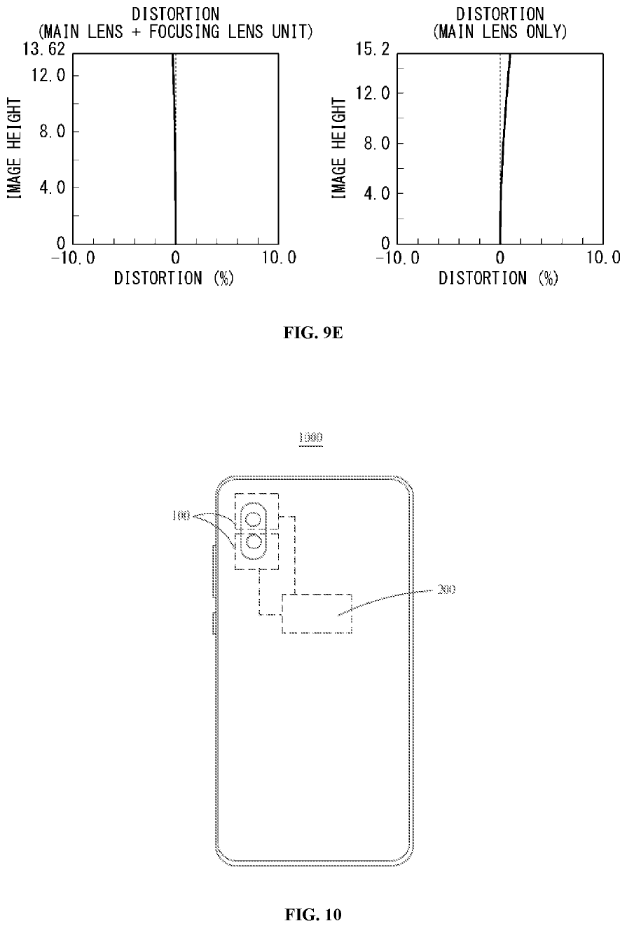

FIG. 9A shows a cross-sectional illustration of an optical lens system in accordance with a ninth embodiment of the present disclosure at the infinity lens position. A main imaging lens comprises lens elements ML1, ML2, ML3, and ML4, and a focusing unit comprises lens elements FL1, FL2, FL3, and FL4. In the focusing lens unit of this embodiment, a first positive lens group consists of FL1, a second negative lens group consists of FL2, a third positive lens group consists of FL3, and a fourth negative lens group consists of FL4.

FIG. 9B shows a cross-sectional illustration of the optical lens system in accordance with the ninth embodiment of the present disclosure at the MOD lens position. The facing lens surfaces between FL1 and FL2 have substantially corresponding surfaces. Also, the facing lens surfaces between FL3 and FL4 have substantially corresponding surfaces.

FIGS. 9A and 9B show that only lens elements FL2 and FL3 of the focusing lens unit are moved in opposite directions to focus a shorter focal length or at infinity focal length. Therefore, the focus mechanism can be easily designed.

Table 17 shows the radius of curvature (r) and the thickness or separation (d) for each of the optical surfaces, and the refractive index (N), the Abbe number (v), and the effective diameter (φ) for each of the lens elements of the low refractive power inner lens focusing system of the ninth embodiment.

TABLE 17

| | | | Thick- | Refractive | Abbe | Effective |
|---|---|---|---|---|---|---|
| Surface | | Radius | ness | Index (N) | Number (v) | Diameter |
| Stop | | Infinity | 0.000 | — | — | 5.5 |
| ML1 | R1 | 4.127 | 1.310 | 1.62 | 63.9 | 5.50 |
| | R2 | 16.656 | 1.300 | | | 5.22 |
| ML2 | R1 | 10.381 | 0.500 | 1.63 | 24.0 | 4.20 |
| | R2 | 3.548 | 0.950 | | | 3.80 |
| ML3 | R1 | −4.698 | 0.810 | 1.63 | 24.0 | 3.86 |
| | R2 | −4.126 | 0.110 | | | 4.04 |
| ML4 | R1 | 5.619 | 0.520 | 1.54 | 55.9 | 4.00 |
| | R2 | 5.692 | 0.600 | | | 4.40 |
| FL1 | R1 | 5.391 | 0.583 | 1.54 | 55.9 | 4.20 |
| | R2 | 23.356 | 0.200 | | | 4.22 |
| FL2 | R1 | 24.829 | 0.460 | 1.54 | 55.9 | 4.22 |
| | R2 | 3.920 | 4.081 | | | 4.20 |
| FL3 | R1 | 51.509 | 2.239 | 1.54 | 55.9 | 7.00 |
| | R2 | −4.927 | 0.250 | | | 7.80 |
| FL4 | R1 | −4.909 | 0.600 | 1.54 | 55.9 | 7.80 |
| | R2 | −20.830 | 1.980 | | | 7.80 |
| Optical | R1 | Infinity | 0.210 | 1.5168 | 64.17 | — |
| Glass | R2 | | 0.300 | | | |

Table 18 shows the aspheric coefficients for each of the optical surfaces of the 1 low refractive power inner lens focusing system, wherein numbers 2, 4, . . . , 10 represent the higher order aspheric coefficients.

TABLE 18
ASPHERICAL COEFFICIENTS

| Surface | | Conic | 2 | 4 | 6 | 8 | 10 |
|---|---|---|---|---|---|---|---|
| ML1 | R1 | 0.0000E+00 | 0.0000E+00 | 0.0000E+00 | 0.0000E+00 | 0.0000E+00 | 0.0000E+00 |
| | R2 | 0.0000E+00 | 0.0000E+00 | 0.0000E+00 | 0.0000E+00 | 0.0000E+00 | 0.0000E+00 |
| ML2 | R1 | 0.0000E+00 | 0.0000E+00 | −2.0089E−03 | −2.1868E−04 | 0.0000E+00 | 0.0000E+00 |
| | R2 | 0.0000E+00 | 0.0000E+00 | 3.1152E−03 | 4.2894E−04 | 0.0000E+00 | 0.0000E+00 |
| ML3 | R1 | 0.0000E+00 | 0.0000E+00 | 2.1457E−02 | −3.3395E−03 | 6.8448E−04 | −7.3115E−05 |
| | R2 | 0.0000E+00 | 0.0000E+00 | 8.8886E−03 | −9.5721E−04 | 2.1785E−04 | −5.5753E−05 |
| ML4 | R1 | 0.0000E+00 | 0.0000E+00 | −3.6958E−02 | 2.6694E−03 | 8.0601E−05 | −9.7079E−05 |
| | R2 | 0.0000E+00 | 0.0000E+00 | −3.5319E−02 | 3.7010E−03 | −3.6609E−04 | −2.9713E−06 |
| FL1 | R1 | 0.0000E+00 | 0.0000E+00 | −3.7304E−03 | 1.1222E−03 | −2.0182E−04 | 1.1506E−05 |
| | R2 | 0.0000E+00 | 0.0000E+00 | −4.1604E−03 | 1.5677E−03 | −2.8025E−04 | 1.5471E−05 |
| FL2 | R1 | 0.0000E+00 | 0.0000E+00 | 1.2956E−03 | −4.0149E−04 | 7.6969E−05 | −1.0129E−05 |
| | R2 | 0.0000E+00 | 0.0000E+00 | 2.3450E−03 | −9.8231E−04 | 1.6513E−04 | −1.5986E−05 |
| FL3 | R1 | 0.0000E+00 | 0.0000E+00 | 4.1735E−04 | 1.4892E−04 | −7.3785E−06 | −3.0296E−08 |
| | R2 | 0.0000E+00 | 0.0000E+00 | 7.2841E−04 | 1.7505E−04 | −8.4763E−06 | 2.8916E−07 |
| FL4 | R1 | 0.0000E+00 | 0.0000E+00 | 1.8799E−03 | −1.8331E−04 | 2.3675E−05 | −3.4696E−07 |
| | R2 | 0.0000E+00 | 0.0000E+00 | 3.1518E−04 | −1.8869E−04 | 1.9955E−05 | −4.1594E−07 |

FIG. 9C shows a comparison of longitudinal spherical aberration of the main imaging lens and a combination of the main imaging lens and the focusing lens unit in accordance with the ninth embodiment of the present disclosure. The comparison shows that the aberration of the main imaging lens only is almost unaffected by adding the focusing lens unit.

FIG. 9D shows a comparison of an astigmatic field of the main imaging lens and a combination of the main imaging lens and the focusing lens unit of the present disclosure in accordance with the ninth embodiment. The comparison shows that the astigmatic field of the main imaging lens only is almost unaffected by adding the focusing lens unit.

FIG. 9E shows a comparison of distortion of the main imaging lens and a combination of the main imaging lens and the focusing lens unit of the present disclosure in accordance with the ninth embodiment. The comparison shows that the distortion of the main imaging lens only is almost unaffected by adding the focusing lens unit.

As shown in the optical data, the low refractive power inner lens focusing systems according to the present disclosure are arranged with a main imaging lens and a focusing unit, which can be inspected independently of each other. Only one lens or a pair of lenses of the focusing lens unit are moved to focus the lens system without changing the TTL so that the focusing mechanism can be very simplified. In addition, the focusing lens unit does not affect the performance of the main imaging lens. In other words, the focusing lens unit can provide various main imaging lenses with focus adjustment function without deterioration of the image quality of the main imaging lens. The low refractive power inner lens focusing unit, also called the focusing lens unit, described in the present disclosure has a very low refractive power and comprises at least one positive lens group and at least one negative lens group, and the negative lens group moves toward the imaging surface to focus at a nearer object distance when focusing from infinity to MOD, and vice versa. The above-mentioned advantages are accomplished when it satisfies the following relations:

0.5≤|1−β\hat{ }2|≤3.5 (i):

Where β is the magnification of the negative lens group of the focusing lens unit,

|Ff|/IMH≥10 (ii):

Where Ff is the focal length of this focusing lens unit, and IMH is the semi-diagonal length of the image sensor.

|Ff/Fmain|≤0.55 (iii):

Where Fmain is the focal length of the combined main imaging lens.

Dmin/φmax<0.2 (iv):

Where Dmin is the distance between the facing lens surfaces between different lens groups of the focusing lens unit, which get close together at the INF lens position and φmax is the maximum optical effective diameter of the lens among the focusing lens unit.

0.5<abs (v):

The condition (i) keeps the amount of the focusing stroke small enough to miniaturize the optical system and avoid the error sensitivity of moving the focusing lens unit becoming too strong, which is disadvantageous in terms of manufacturing and mass production. From this viewpoint, the following range is more preferable.

0.7≤|1−β\hat{ }2|≤3.0 (i)-2:

The condition (ii) avoids the situation where the refractive power of the focusing unit becomes unnecessarily large with respect to the sensor size, which makes it unsuitable for miniaturization and causes deterioration of manufacturing error sensitivity and deterioration of mass productivity due to a substantial effect on the performances of the main imaging lens. From this viewpoint, the following range is more preferable.

Preferably, |Ff|/IMH≥17 (ii)-2:

The condition (iii) avoids deterioration of manufacturing and mass productivity caused by making the refractive power of the focusing lens unit too strong and reducing the versatility of this optical system due to significant changes of performance of the main imaging lens when the focusing lens unit is combined with the main imaging lens. From this viewpoint, the following range is more preferable.

|Ff/Fmain|≤0.4 (iii)-2:

The condition (iv) keeps the effect by the focusing lens unit on the main imaging lens small enough to maintain the optical performances of the main imaging lens. From this viewpoint, the following range is more preferable.

Dmin/φmax<0.1 (iv)-2:

The conditions (v) keeps the situation where the facing lens surfaces close enough to each other. When the facing lens surfaces between different lens groups of the focusing lens unit, which get close together at the INF lens position, are too different from each other to approximate them as a single lens unit with low aberration as the two surfaces approach each other, it becomes difficult to maintain the optical performance of the main imaging lens. From this viewpoint, the following range is more preferable.

0.5<abs (v)-2:

With the low refractive power inner lens focusing unit of the present disclosure, the main imaging lens does not need to have a focusing optical function, which enables a compact design as well as inexpensive mass-production. Further, in the lens performance inspection process, various inspections can be performed only with the main lens separately from the focusing lens unit, which facilitates manufacturing. On the other hand, by focusing with this focusing lens unit, it is possible to avoid changing the TTL and increasing the total length of the lens. It is possible to adopt the inner focusing method in which the total length does not change and the MOD is short. Further, since the focusing lens unit according to the present disclosure has very low refractive power, it can have a very small effect on the optical performances of the main imaging lens. Therefore, it can keep the manufacturing error sensitivity at a very low level, which enables realization of high manufacturability and mass productivity.

Further, a camera is provided. The camera in the present disclosure comprises the low refractive inner focusing lens system of the present disclosure and an image sensor. The low refractive inner focusing lens system is configured to input light, which is used to project an image to the image sensor; and the image sensor is configured to convert the image into digital image data. The camera has a fixed TTL, which is preferable for installation in a mobile device.

FIG. 10 shows a terminal 1000 disclosed in the present disclosure. The terminal 1000 comprises cameras 100 provided in the above implementations and a GPU 200. The camera 100 is configured to convert an image through a low refractive inner focusing lens system of the present disclosure to digital image data and input the digital image data into the GPU 200, and the GPU 200 is configured to process the image data received from the camera.

In FIG. 10, terminal 1000 comprises two cameras 100. However, the terminal may comprise a single camera or two or more cameras and it (or they) could be connected to at least one GPU 200. The cameras 100 can be applied as high resolution mobile device cameras, such as mobile phone cameras, because of the high image quality, fixed TTL, and high productivity.

A person skilled in the art would understand that there is difficulty in having a high productivity in a mass product inner focusing lens system with the fixed TTL. The present disclosure satisfies these dual requirements by satisfying the above mentioned relations.

In the present disclosure, the term “low refractive power” should be understood as satisfying the relation |Ff/Fmain|≤0.55, where Ff is the focal length of the inner focusing lens unit, and Fmain is the focal length of the main imaging lens which are to be combined.

Although the lens system according to the present disclosure can be applied especially to mobile phone cameras, it can be also applied to cameras in any mobile device such as tablet type devices and wearable devices.

Although preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. An inner focusing lens unit comprising:
a positive lens group; and
a negative lens group configured to:
be placed within a flange back between an imaging lens and an image sensor surface; and
provide a focusing function when moved toward the imaging surface to focus at a nearer object distance when focusing from infinity (INF) to a minimum object distance (MOD).

2. The inner focusing lens unit of claim 1, wherein a magnification β of the negative lens group satisfies the following relation: 0.5≤|1−β\hat{ }2|≤3.5.

3. The inner focusing lens unit of claim 1, wherein a magnification β of the negative lens group satisfies the following relation: 0.7≤|1−β\hat{ }2|≤3.

4. The inner focusing lens unit of claim 1, wherein a focal length Ff of the inner focusing lens unit and a semi-diagonal length IMH of the image sensor surface satisfies the following relation: |Ff|/IMH≥10.

5. The inner focusing lens unit of claim 1, wherein a focal length Ff of the inner focusing lens unit and a semi-diagonal length IMH of the image sensor surface satisfies the following relation: |Ff|/IMH≥17.

6. The inner focusing lens unit of claim 1, wherein a first focal length Ff of the inner focusing lens unit and a second focal length Fmain of the imaging lens satisfy the following relation: |Ff/Fmain|≤0.55.

7. The inner focusing lens unit of claim 1, wherein a first focal length Ff of the inner focusing lens unit and a second focal length Fmain of the imaging lens satisfy the following relation: |Ff/Fmain|≤0.4.

8. The inner focusing lens unit of claim 1, wherein a distance Dmin between facing lens surfaces of different lens groups of the inner focusing lens unit at an INF lens position and a maximum optical effective diameter φmax among the inner focusing lens unit satisfies the following relation: Dmin/φmax<0.2.

9. The inner focusing lens unit of claim 1, wherein a distance Dmin between facing lens surfaces of different lens groups of the inner focusing lens unit at an INF lens position and a maximum optical effective diameter φmax among the inner focusing lens unit satisfies the following relation: Dmin/φmax<0.1.

10. The inner focusing lens unit of claim 1, wherein facing lens surfaces between different lens groups of the inner focusing lens unit have substantially corresponding surfaces, and wherein a first surface shape of a surface on an object side Sob (h) of the facing lens surfaces defined by a lens diameter height h and a second surface shape on an image plane side of the facing lens surfaces satisfies the following relation: 0.5<abs [Sob(h)/Sim(h)]<2.0.

11. The inner focusing lens unit of claim 1, wherein facing lens surfaces between different lens groups of the inner focusing lens unit have substantially corresponding surfaces, and wherein a first surface shape of a surface on an object side Sob (h) of the facing lens surfaces defined by a lens diameter height h and a second surface shape on an image plane side of the facing lens surfaces satisfies the following relation: 0.5<abs [Sob(h)/Sim(h)]<1.7.

12. The inner focusing lens unit of claim 1, wherein facing lens surfaces between different lens groups of the inner focusing lens unit have substantially corresponding surfaces, and wherein a first radius of a first surface on an object side Rob of the facing lens surfaces and a second radius of a second surface on an image side of the facing lens surfaces satisfies the following relation: 0.5<Rob/Rim<2.0.

13. The inner focusing lens unit of claim 1, wherein the negative lens group is further configured to provide the focusing function when moved away from the imaging surface to focus at a farther object distance when focusing from the MOD to INF.

14. A low refractive inner focusing lens system, comprising:
an imaging lens configured to perform as an individual lens unit; and
an inner focusing lens unit comprising:
a positive lens group; and
a negative lens group configured to:
be placed within a flange back between the imaging lens and an image sensor surface; and
provide a focusing function when moved toward the imaging surface to focus at a nearer object distance when focusing from infinity (INF) to a minimum object distance (MOD).

15. The low refractive inner focusing lens system of claim 14, wherein a magnification β of the negative lens group satisfies the following relation: 0.5≤|1−β\hat{ }2|≤3.5.

16. The low refractive inner focusing lens system of claim 15, wherein a focal length Ff of the inner focusing lens unit and a semi-diagonal length IMH of the image sensor surface satisfies the following relation: |Ff|/IMH≥10.

17. The low refractive inner focusing lens system of claim 15, wherein a first focal length Ff of the inner focusing lens unit and a second focal length Fmain of the imaging lens combined satisfies the following relation: |Ff/Fmain|≤0.55.

18. The low refractive inner focusing lens system of claim 15, wherein a distance Dmin between facing lens surfaces of different lens groups of the inner focusing lens unit at an INF lens position, and a maximum optical effective diameter φmax among the inner focusing lens unit satisfies the following relation: Dmin/φmax<0.2.

19. The low refractive inner focusing lens system of claim 15, wherein facing lens surfaces between different lens groups of the inner focusing lens unit have substantially corresponding surfaces, and wherein a first surface shape of a surface on an object side Sob (h) of the facing lens surfaces defined by a lens diameter height h and a second surface shape on an image plane side of the facing lens surfaces satisfies the following relation: 0.5<abs [Sob(h)/Sim(h)]<1.8.

20. A terminal comprising:
a camera comprising:
a low refractive inner focusing lens system configured to project an image; and
an image sensor is configured to:
receive the image from the low refractive inner focusing lens system; and
convert the image into digital image data;
an inner focusing lens unit comprising:
a positive lens group; and
a negative lens group configured to:
be placed within a flange back between the imaging lens and an image sensor surface; and
provide a focusing function when moved toward the imaging surface to focus at a nearer object distance when focusing from infinity (INF) to a minimum object distance (MOD); and
a graphic processing unit (GPU) coupled to the camera and configured to receive and process the digital image data.
